(19) United States
(12) Patent Application Publication
(10) Pub. No.: US 2023/0244210 A1
(43) Pub. Date: Aug. 3, 2023

(54) DATA PROCESSING APPARATUS, METHOD, AND STORAGE MEDIUM

(71) Applicant: KABUSHIKI KAISHA TOSHIBA, Tokyo (JP)

(72) Inventors: Keisuke KAWAUCHI, Kawasaki (JP); Takayuki ITOH, Kawasaki (JP); Wataru WATANABE, Tokyo (JP); Jumpei ANDO, Yokohama (JP); Toshiyuki ONO, Kawasaki (JP)

(73) Assignee: KABUSHIKI KAISHA TOSHIBA, Tokyo (JP)

(21) Appl. No.: 17/899,784

(22) Filed: Aug. 31, 2022

(30) Foreign Application Priority Data
Feb. 2, 2022 (JP) 2022-015113

(51) Int. Cl. G05B 19/4155

(52) U.S. Cl. CPC G05B 19/4155; G05B 2219/32027

(57) ABSTRACT

In general, according to one embodiment, a data processing apparatus includes a processor including hardware. The processor acquires state data related to a state of each product and order data related to order related to manufacturing of each product. The processor calculates a first score by using the acquired state data and the acquired order data. The first score regards a change in the acquired state data and is based on a first change model. The first change model represents the change in the state data using the order data. The processor outputs the first score.

### CROSS-REFERENCE TO RELATED APPLICATIONS

This application is based upon and claims the benefit of priority from the Japanese Patent Application No. 2022-015113, filed Feb. 2, 2022, the entire contents of which are incorporated herein by reference.

### FIELD

Embodiments described herein relate generally to a data processing apparatus, a method, and a storage medium.

### BACKGROUND

In the manufacturing industry, it is important to identify the cause of a specific state of a product at an early stage. For example, when a product is in an abnormal state different from a normal state, identifying the cause of the abnormal state at an early stage leads to maintenance and improvement of yield. In many manufacturing industries, various kinds of data acquired during the manufacturing process are monitored, and this helps detect abnormality and identify the cause.

The contents of the data are various. For example, data on conditions for manufacturing a product includes contents such as the name of a material used for manufacturing the product and the name of an apparatus used for manufacturing the product. In addition, data on the state of the product includes contents such as the size, physical characteristics, and appearance quality of the manufactured product. Usually, the data is often associated with an ID, a serial number, or the like, which is information that can identify each individual of the product.

By monitoring each item of individual data of the product, it may be possible to detect an abnormality of the product or the apparatus. For example, when a value of individual data of a product included in a product group manufactured in a certain period is different from a normal value, there is a possibility that an abnormality has occurred in the product. In this case, manufacturing data including data of conditions for the manufacturing is reviewed in order to search for the cause of the abnormality of the product. For example, when the fact that the abnormal product was manufactured only by a specific apparatus is identified from the manufacturing data, the apparatus may be the cause of the abnormality.

The more steps required to complete the product and the more apparatuses used to complete the product, the more data required to be monitored. Furthermore, with the recent development of Internet of Things (IoT) technologies, various data related to manufacturing can be easily acquired. Therefore, the number of items of manufacturing data has significantly increased. As a result, it is difficult to monitor manufacturing data manually. Under such circumstances, there is a demand for an apparatus that supports monitoring of manufacturing data by a user.

### BRIEF DESCRIPTION OF THE DRAWINGS

FIG. 1 is a block diagram illustrating a data processing apparatus according to a first embodiment.

FIG. 2 is a diagram illustrating an example of manufacturing data.

FIG. 3 is a flowchart illustrating processing of calculating a first score in a first calculation unit.

FIG. 4 is image diagram illustrating the application of a regression model.

FIG. 5 is a diagram illustrating an example of results of sorting data by an output unit.

FIG. 6 is a diagram illustrating an example of a diagram generated according to visualized data based on a result of applying a first change model to state data.

FIG. 7 is a diagram illustrating an example of a display screen of an analysis result displayed on a display unit when both the first score and the result of applying the first change model are received.

FIG. 8 is a block diagram illustrating a data processing apparatus according to a second embodiment.

FIG. 9 is a flowchart illustrating processing of calculating a second score in a second calculation unit.

FIG. 10A is a diagram illustrating an example of data generated by an output unit when manufacturing condition data that has caused a change in state data has been acquired.

FIG. 10B is a diagram illustrating an example of data generated by the output unit when manufacturing condition data that has caused a change in the state data has not been acquired.

FIG. 11 is a diagram illustrating an example of visualization with a scatter diagram in which order data, manufacturing condition data, and state data are combined.

FIG. 12 is a diagram illustrating an example of a display screen of an analysis result displayed on a display unit when a first score, a result of applying a first change model, and a second score are received.

FIG. 13 is a diagram illustrating an example of a display screen of an analysis result when a scatter diagram in which order data, manufacturing condition data, and state data are combined is displayed.

FIG. 14 is a diagram illustrating an example of a display screen when the degree of freedom in calculating the first score matches the number of elements of the manufacturing condition data when the second score is calculated.

FIG. 15 is a block diagram illustrating a data processing apparatus according to a third embodiment.

FIG. 16 is a diagram illustrating an example of a display screen displayed on a display unit in the third embodiment.

FIG. 17 is a schematic diagram illustrating a relationship between an information amount change button, a switch button, and an amount of information of a second display region according to the third embodiment.

FIG. 18 is a diagram illustrating an example of a display screen including an interface for accepting an operation of changing a priority of a first display region and an operation of changing a priority of a second display region.

FIG. 19 is a diagram illustrating a modification in which details of an analysis result are displayed.

FIG. 20 is a block diagram illustrating a data processing apparatus according to a fourth embodiment.

FIG. 21 is a diagram illustrating a relationship between manufacturing data and manufacturing process data.

FIG. 22 is a diagram illustrating an example of a display screen displayed on a display unit in the fourth embodiment.

FIG. 23 is a diagram illustrating a relationship between the manufacturing data and user data.

FIG. 24 is a block diagram illustrating a data processing apparatus according to a fifth embodiment.

FIG. 25 is a block diagram illustrating a hardware configuration of each of the data processing apparatuses.

### DETAILED DESCRIPTION

In general, according to one embodiment, a data processing apparatus includes a processor including hardware. The processor acquires state data related to a state of each product and order data related to order related to manufacturing of each product. The processor calculates a first score by using the acquired state data and the acquired order data. The first score regards a change in the acquired state data and is based on a first change model. The first change model represents the change in the state data using the order data. The processor outputs the first score.

### First Embodiment

A first embodiment will be described. A data processing apparatus according to the first embodiment estimates a cause of a certain state of a product by using information of order related to the product, and visualizes the cause based on a result of the estimation. As a result, the data processing apparatus assists the user in finding the cause of the certain state of the product.

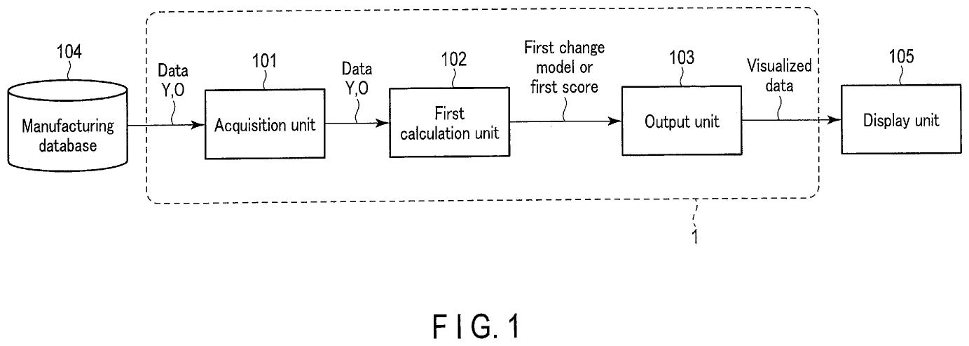

FIG. 1 is a block diagram illustrating the data processing apparatus according to the first embodiment. The data processing apparatus 1 includes an acquisition unit 101, a first calculation unit 102, and an output unit 103. The data processing apparatus 1 is connected to a manufacturing database 104 and a display unit 105. The manufacturing database 104 and the display unit 105 may be provided separately from the data processing apparatus 1, for example, or may be provided in the data processing apparatus 1.

The acquisition unit 101 acquires manufacturing data from the manufacturing database 104. The manufacturing data includes key data for identifying each product, state data related to a state of each product, and order data related to order related to the manufacturing of each product. The acquisition unit 101 inputs the manufacturing data to the first calculation unit 102.

The first calculation unit 102 calculates a first score regarding a change in the state data using the state data and the order data. The first score is a score indicating an extent to which a first change model fits the actual state data and the order data. The first change model is a model representing a change in the state data using the order data.

The output unit 103 generates visualized data from the first score or information describing the first score. Then, the output unit 103 outputs the visualized data to the display unit 105. The visualized data is data for visually presenting the user with a possible cause of a change in the state data.

The manufacturing database 104 stores the manufacturing data. The manufacturing database 104 may be configured as a general relational database management system (RDBMS). The manufacturing database 104 may be, for example, a Not only SQL (NoSQL) database. In addition, the manufacturing data stored in the manufacturing database 104 may be configured as a file in a predetermined format such as CSV (Comma Separated Value).

The display unit 105 displays various types of information based on the visualized data. The display unit 105 can be constituted by any of various displays such as a liquid crystal display and an organic EL display.

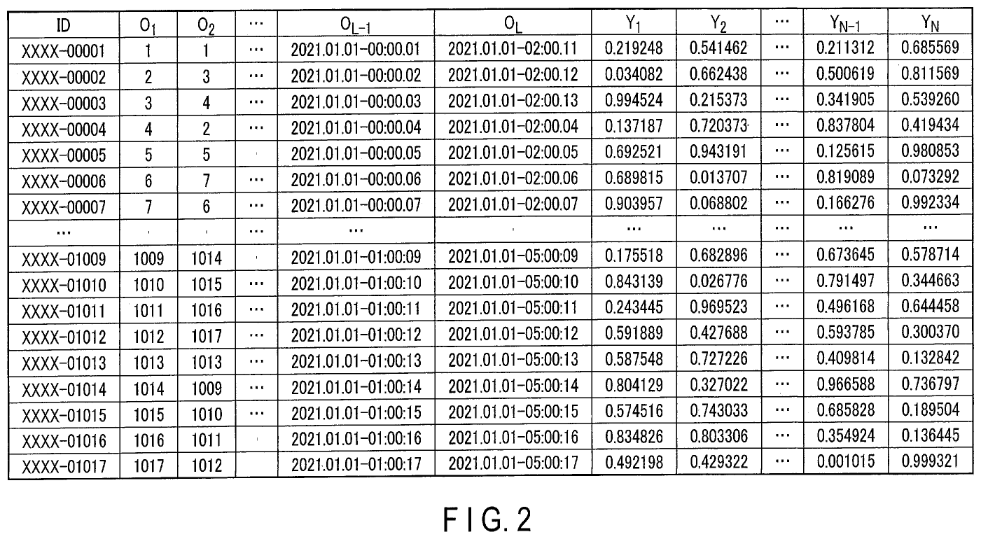

Next, an operation of the data processing apparatus 1 according to the first embodiment will be described. First, an operation of the acquisition unit 101 will be described. The acquisition unit 101 acquires manufacturing data to be used for calculating the first score from the manufacturing database 104. The manufacturing data will be described below in detail. FIG. 2 is a diagram illustrating an example of the manufacturing data. The vertical direction in the manufacturing data illustrated in FIG. 2 is referred to as a column direction, and the horizontal direction in the manufacturing data illustrated in FIG. 2 is referred to as a row direction. In this case, the column direction of the manufacturing data represents items of the state and order of the product. The row direction of the manufacturing data represents data of each individual of the product.

In the example of FIG. 2, the manufacturing data includes IDs as key data. The key data is useful in identifying a certain state, for example, an abnormal state. If it is not necessary to identify a product, the manufacturing data may not include the key data. Furthermore, when the manufacturing data, is recorded in the CSV format or the like and does not include special key data, the acquisition unit 101 may assign a serial number or the like to the acquired manufacturing data or the like as key data.

In the embodiment, the acquisition unit 101 acquires at least two or more pieces of manufacturing data satisfying conditions, that is, two or more rows of manufacturing data. The acquisition unit 101 inputs the manufacturing data to the first calculation unit 102. The condition for acquiring the manufacturing data is, for example, whether or not an ID included in the manufacturing data is included in an ID list of the product as a target for identifying the cause. Under such an acquisition condition, the acquisition unit 101 may acquire manufacturing data having the ID included in the list. The number of pieces of manufacturing data acquired by the acquisition unit 101, that is, the number of rows is represented as D.

The condition for acquiring the manufacturing data may be designated by the user. For example, the condition may be designated to acquire manufacturing data for a product group manufactured in any period of one hour, one day, or the like. The state data and the order data which are elements of the manufacturing data will be further described below.

First, the order data will be described. For the following description, the order data is represented by a set {Oₖ: k=1 . . . L}. Here, L represents the number of items of the acquired order data. The product to be analyzed in the present embodiment is manufactured according to specific L types of order. The order data is data related to the order related to the manufacturing of the product. The order data may include, for example, data of the order in which processes are started in manufacturing of the product, that is, the order in which tasks for the product are started. As described above, when the order data is data indicating the order in which the processes are started, the value of L in the order data is equal to the number of processes.

The order data may not be data in units of processes. For example, the order data may be data in units of manufacturing lines, data in units of manufacturing facilities, data in units of manufacturing apparatuses, data in units of lots of products, data in units of batches, and data in units of manufacturing. In addition, the order data may be data in units of manufacturing bases or the like. For example, the order data in a case where the product reaches an inspection site from a factory A through a factory B and a factory C may be recorded in a time zone or the like in which the product is at each factory and the inspection site.

Furthermore, the order in the order data may be represented by, for example, serial numbers from 1 or may be represented by time. For example, the order data may be data of the start time of each of the processes in manufacturing the product or the time when a task for the product is started in each of the processes. In FIGS. 2, 0₁ and O₂ indicate examples in which the order data is recorded based on serial numbers, and O_{L-1} and O_{L} indicate examples in which the order data is recorded based on time. As illustrated in FIG. 2, the order data is not necessarily recorded in a unified format.

In addition, the order data may be, for example, instead of the start time, time of passage, time of completion, a number representing a certain period or a certain number of product units, a character string, a serial number, a product serial number, an ID, the number of times of processing of an apparatus, and other various data from which the order related to the manufacturing of the product can be grasped.

In addition, in the embodiment, for example, a situation is assumed in which the product is automatically or manually moved by a belt conveyor and a carriage, or the like, and processed or inspected by predetermined equipment or the like. In addition, for example, even in a situation where the product is fixed and is processed or inspected by equipment or the like different for each process, the order can be specified, and thus the techniques described in the first embodiment can be applied.

Further, the product with which the order data is associated may not be a product that undergoes multiple processes. For example, even if the processes are not clearly defined, in a case where the product undergoes processes by a plurality of apparatuses or in a case where a plurality of tasks are performed on the product, the order data may indicate the order in which the product reaches the apparatuses or the order in which the product reaches work places.

Furthermore, in a case where the order data is recorded based on time, the order data may include data of products in the same order due to the effect of the accuracy of recording the time or the like. However, it is desirable that the order data be recorded so that the order is unique.

Next, the state data will be described. For the following description, the state data is represented by a set {Yᵢ: i=1 . . . N}. Here, N represents the number of items of the acquired state data.

The state data Yᵢ represents, for example, the state of each product. The state of each product is represented, for example, as a measured value obtained by performing an inspection on the product. The state data Yᵢ includes, for example, data of measured values related to inspection items, such as a dimension and weight of the product. In addition, depending on the type of product, the state data Yᵢ may include data of measured values such as electrical characteristics and physical characteristics of the product. As described above, the state data Yᵢ can be, for example, a measured value related to an inspection item at the time of shipment of the product.

The state data Yᵢ may be any data that is not the measured value related to the inspection item and from which the state of the product can be grasped. For example, the state data Yᵢ may be data of a result of some determination. For example, the state data Yᵢ may be an integer value representing a 5-point scale on the quality of the product, a binary flag representing a result of determining whether or not the product is good, or the like. The acquisition unit 101 may acquire any state data Yᵢ determined by the user to be useful for analysis.

As illustrated in FIG. 2, the state data and the order data may be data combined into one, or may be separate data associated by a common ID.

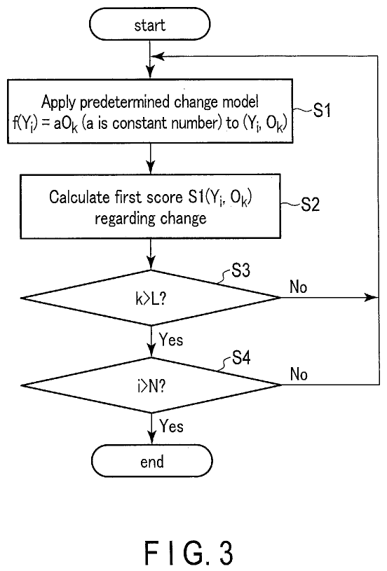

Next, an operation of the first calculation unit 102 will be described. When receiving the state data Yᵢ and order data Oₖ from the acquisition unit 101, the first calculation unit 102 calculates a first score S1(Yᵢ, Oₖ). FIG. 3 is a flowchart illustrating processing of calculating the first score in the first calculation unit 102.

First, the first calculation unit 102 initializes k and i to initial values, for example, 1. Then, in step S1, the first calculation unit 102 applies a first change model ƒ(Yᵢ)=aOₖ to one set of the state data Yᵢ and the order data Oₖ. The first change model is a model representing a change in the state data Yᵢ using the order data Oₖ. In the embodiment, the first change model is, for example, a regression model using the order data Oₖ as a step basis.

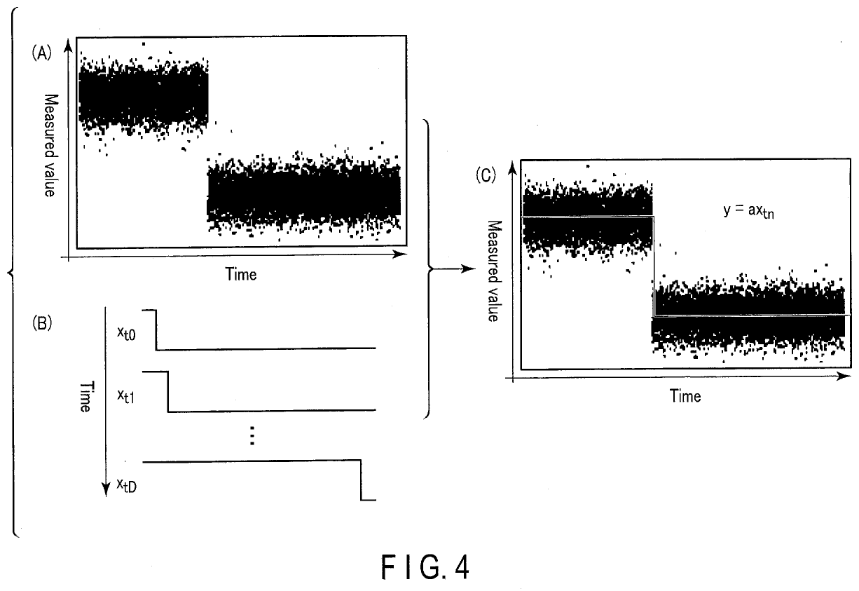

FIG. 4 is image diagram illustrating the application of the regression model. (A) of FIG. 4 is a scatter diagram illustrating a distribution of the state data Yᵢ rearranged in order of points of time of certain order data Oₖ. In the (A), the vertical axis represents a measured value of the state data Yᵢ, and the horizontal axis represents a value of each point of time of the order data Oₖ. Furthermore, (B) of FIG. 4 illustrates the step basis generated from the order data Oₖ. When the distribution of the state data Yᵢ over time and the distribution of the state data Yᵢ at time 0 are obtained, and basis functions xₜₙ that change stepwise at time to (n=0 . . . D) of the certain order data Oₖ are considered, a change in the state data Yᵢ over time can be represented by a weighted sum of these basis functions xₜₙ. This weight is synonymous with a regression coefficient in the regression model using the basis functions xₜₙ. The first calculation unit 102 calculates the weight of each basis function xₜₙ, that is, the regression coefficient in the function ƒ(Yᵢ) based on the state data Yᵢ and the order data Oₖ, thereby applying the first change model to the state data Yᵢ and the order data Oₖ. For example, the first calculation unit 102 calculates the weight by a method such as a least squares method using the state data Yᵢ arranged in the order represented by the order data Oₖ. (C) of FIG. 4 illustrates a result of applying the first change model illustrated in (B) to the state data Yᵢ illustrated in (A). That is, (C) shows that the first change model that most suitably fits the scatter diagram illustrated in (A) is y=axₜₙ.

In step S2, the first calculation unit 102 calculates a first score S1 (Yᵢ, Oₖ) regarding a change in the state data Yᵢ. The first score S1 (Yᵢ, Oₖ) is the goodness of fit of the first change model to the state data Yᵢ and the order data Oₖ. For example, as the first score, an existing evaluation index such as a residual sum of squares (RSS) or a log likelihood can be used. As other examples of the first score, a correlation coefficient, a regression coefficient, a mean square error (MSE), a root mean square error (RMSE), a mean absolute error (MAE), a determination coefficient (R2), indexes derived from these evaluation indexes, and the like can be used. Furthermore, the first score may be an evaluation index calculated from a plurality of indexes among these indexes.

In the embodiment, as a more preferable example, a score indicating a sum of the goodness of fit to the data and a penalty for complexity of the model may be used as the first score. The change in the state data Yᵢ includes various types of noise caused by various events different from original causes, such as a measurement error and replacement of processes in addition to a change caused by the original cause of a specific state of the product. In a case where the effect of noise is large, if only the goodness of fit is the score, the score of the model that excessively fits the change including the noise becomes high. In this case, it is difficult to grasp the change in the state data Yᵢ due to the cause. In the embodiment, the Bayesian Information Criterion (BIC), known as a score that represents the sum of the goodness of fit to the data and the penalty for the complexity of the model, is used as the first score. The BIC is calculated according to Equation (1). In Equation (1), In(L) is the maximum log likelihood, n is the number of samples, and k is the degree of freedom of data.

BIC=−2·ln(L)+k ln(n) (1)

In addition, under the Gaussian error model, Equation (1) can be rewritten into Equation (2). In Equation (2), n is the number of samples, Yiₜᵣᵤₑ is a measured value of the state data Yᵢ, and Yi_{pred} is a predicted value of the state data Yᵢ calculated from the first change model.

$$BIC = n \cdot ln ( \frac{\sum {( {Yi}_{true} - {Yi}_{pred} )}^{2}}{n} ) + k ln ( n ) \qquad ( 2 )$$

In Equation (1) or (2), in a case where the value of the BIC is small, the value of the BIC means that the goodness of fit of the model to the data is high. In a case where the value of the BIC is small, it can be considered that the order data Oₖ is highly likely to be related to the cause of the change in the state data Yᵢ. By scoring the relationship between the order data Oₖ and the state data Yᵢ in this manner, it is possible to evaluate, as a numerical value, an extent to which the first change model ƒ(Yᵢ)=aOₖ can explain the change in the state data Yᵢ.

Here, the description returns to FIG. 3. In step S3, the first calculation unit 102 determines whether k is larger than L. In a case where it is determined in step S3 that k is not larger than L, the first calculation unit 102 adds 1 to k and then returns the processing to step S1. In a case where it is determined in step S3 that k is larger than L, that is, in a case where it is determined that the processing for all the order data Oₖ for the current state data Yᵢ has been completed, the first calculation unit 102 causes the processing to proceed to step S4.

In step S4, the first calculation unit 102 determines whether i is larger than N. In a case where it is determined in step S4 that i is not larger than N, the first calculation unit 102 adds 1 to i and then returns the processing to step S1. In a case where it is determined in step S4 that i is larger than N, that is, in a case where it is determined that the processing for all the order data Oₖ for all the state data Yᵢ has been completed, the first calculation unit 102 ends the processing illustrated in FIG. 3. In this case, the first calculation unit 102 outputs the first score or information describing the first score obtained in the processing illustrated in FIG. 3 to the output unit 103. The information describing the first score is, for example, a result of applying the first change model to the state data Yᵢ to calculate the first score. The result of applying the first change model to the state data Yᵢ to calculate the first score can be, for example, data of a function representing the state data Yᵢ, the order data Oₖ, and the first change model that most suitably fits the state data Yᵢ and the order data Oₖ.

In this manner, the first calculation unit 102 applies the first change model to the state data Yᵢ to calculate the first score S1(Yᵢ, Oₖ). As a result, the change in the state data Yᵢ can be grasped as a numerical value, and the cause of the change in the state data Yᵢ can be identified.

In the embodiment, it is assumed that a change that is the cause occurs once or several times in a certain period, so that an index with a penalty for complexity, such as the BIC, is suitable. On the other hand, the first score is not necessarily limited to the BIC. For example, as the first score, the Akaike information criterion (AIC), the deviation degree information criterion (DIC), the generalized information criterion (GIC), the widely applicable Akaike information criterion (WAIC), and the widely applicable Bayesian information criterion (WBIC) may be used, or derived indexes thereof may be used.

In the embodiment, the step basis is generated from the order data. On the other hand, a basis other than the step basis can be used as long as a change in the state data Yᵢ can be captured. For example, a sigmoid basis, a ramp basis, or the like may be used, or a Fourier basis, a wavelet basis, or the like may be used.

Furthermore, in the above-described example, the first change model is a regression model. On the other hand, other models can be used as long as a change in the state data Yᵢ can be captured. For example, in a case where the moving average model is used as the first change model, noise that is estimated to have a low relationship with the cause of the change in the state data Yᵢ can be removed. Such a first change model can handle a change that is more likely to be the cause. In a case where the moving average model is used as the first change model, not the BIC or the like but a threshold for detecting a change, the number of changes, and the like can be used as the first score. Furthermore, the first score may be directly calculated by a machine learning method such as a support vector machine, deep learning, or the like.

Next, an operation of the output unit 103 will be described. After the first score is calculated by the first calculation unit 102, the output unit 103 generates visualized data from the first score or information describing the first score.

First, an operation of the output unit 103 in a case where the output unit 103 receives the first score from the first calculation unit 102 will be described. The same number of first scores S1(Yᵢ, Oₖ) as the number of combinations of the state data Yᵢ and the order data Oₖ may be present. The output unit 103 may sort the first scores S1(Yᵢ, Oₖ), for example, in the order in which the order data Oₖ has been acquired. Then, the output unit 103 may generate visualized data based on the sorted data, and output the generated visualized data as an analysis result to the display unit 105. In addition, the output unit 103 may sort the order data Oₖ in the order of the first scores S1(Yᵢ, Oₖ). Then, the output unit 103 may generate visualized data based on the sorted data, and output the generated visualized data as an analysis result to the display unit 105. In this case, the visualized data can be generated such that the first scores S1(Yᵢ, Oₖ) and the order data Oₖ are displayed in a ranking format. Therefore, the user can check the results in order of importance by checking the order data Oₖ in the ranking order.

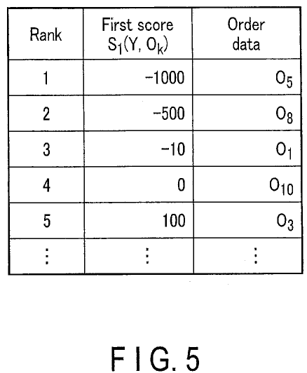

FIG. 5 is a diagram illustrating an example of results of sorting the data by the output unit 103. FIG. 5 illustrates an example in which the order data Oₖ is sorted in ascending order of the values of the first scores S1(Yᵢ, Oₖ), that is, in order of likelihood of being related to the cause of a change in the state data Yᵢ. Since the first scores S1(Yᵢ, Oₖ) and the order data Oₖ are displayed on the display unit 105, the user can consider the cause of the change in the state data Yᵢ from displayed numerical values.

Next, an operation of the output unit 103 in a case where the output unit 103 receives, from the first calculation unit 102, a result of applying the first change model as information describing the first change model will be described. When receiving the result of applying the first change model, the output unit 103 generates, from the result of applying the first change model, visualized data in a format that is, for example, a diagram and enables the user to visually recognize the data. By using the result of applying the first change model, the user can check a change point in the distribution of the state data Yᵢ as visual information, instead of a numerical value such as the first score. This allows the user to more intuitively understand the result.

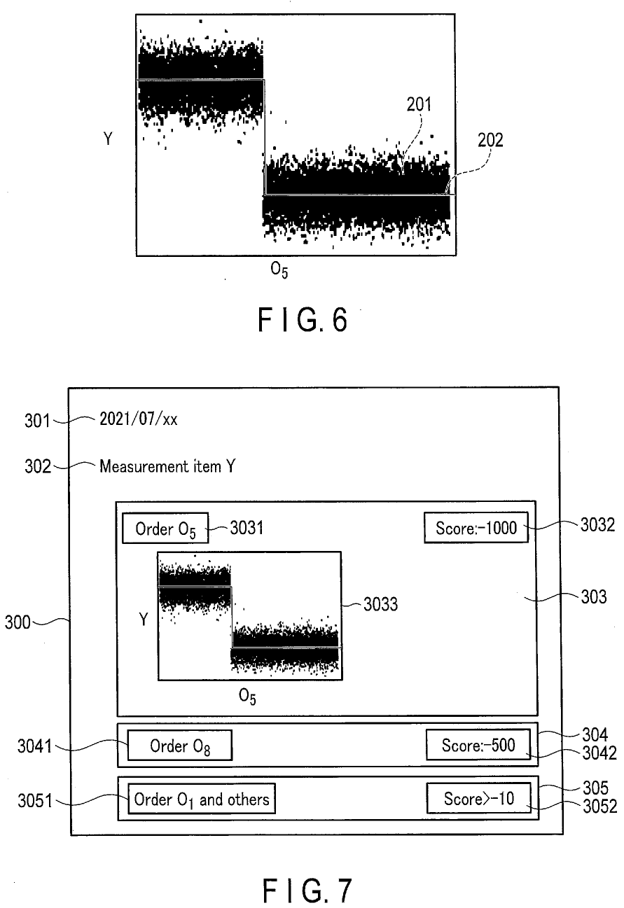

FIG. 6 is a diagram illustrating an example of a diagram generated from the visualized data based on the result of applying the first change model to the state data Yᵢ. FIG. 6 illustrates a diagram generated based on visualized data based on a result of applying a first change model generated from order data O_{S} having the smallest first score in FIG. 5. In FIG. 6, the vertical axis represents a measured value of the state data YL, and the horizontal axis represents each point of time of the order data O_{S}. A scatter diagram 201 illustrated in FIG. 6 is a scatter diagram of the state data Yᵢ arranged in the order of the points of time of the order data O_{S}. The output unit 103 rearranges the state data Yᵢ in the order of the points of time of the order data O_{S}, and plots points representing the rearranged state data Yᵢ at positions corresponding to the points of time. A polygonal line 202 illustrated in FIG. 6 is a polygonal line representing the first change model applied to the state data Yᵢ illustrated in the scatter diagram 201. By displaying the diagram as illustrated in FIG. 6, the user can intuitively understand an extent to which the first change model fits the distribution of the state data Yᵢ. In this way, a degree of change in the state data Yᵢ can be visually indicated to the user.

When receiving both the first score and the result of applying the first change model, the output unit 103 may combine the first score and the result of applying the first change model to generate visualized data that can be displayed. As a result, the user can search for the cause of the change in the state data Yᵢ from numerical values and the scatter diagram.

Here, the format of the visualized data will be described. The visualized data can be generated as, for example, image data or diagram data. In addition, the visualized data may be data in a format displayable on the display unit 105, for example, the Hypertext Markup Language (html), the Extensible Markup Language (xml), or JavaScript (registered trademark) Object Notation (JSON).

FIG. 7 is a diagram illustrating an example of a display screen of an analysis result displayed on the display unit 105 when the output unit 103 receives both the first score and the result of applying the first change model. The display screen illustrated in FIG. 7 is displayed based on the visualized data. As illustrated in FIG. 7, the display screen of the analysis result includes a first display region 300. The first display region 300 includes a creation date display field 301, a state data name display field 302, and second display regions 303, 304, and 305. FIG. 7 illustrates an example of a display screen in a case where one piece of state data Yᵢ to be analyzed is present. When two or more pieces of state data Yᵢ are present, first display regions 300 for all the state data Yᵢ may be displayed side by side. Furthermore, in a case where any score is calculated for each piece of state data Yᵢ, the first display region 300 for each piece of the state data Yᵢ may be displayed in the ranking order based on the scores.

The creation date display field 301 is a display field for displaying, for example, a creation date of manufacturing data used for analysis as information to be analyzed.

The state data name display field 302 is a display field for displaying the name of the state data Yᵢ to be analyzed.

The second display regions 303, 304, and 305 are display regions for displaying information on a combination of the state data Yᵢ and the order data Oₖ displayed in the corresponding first display region 300. A maximum of L second display regions can be provided for one first display region.

The second display regions 303, 304, and 305 include order data name display fields 3031, 3041, and 3051, respectively. In addition, each of the second display regions 303, 304, and 305 includes at least one of a display region for a first score and a display region for a diagram representing a result of applying the first change model. For example, the second display region 303 includes both a first score display region 3032 and a display region 3033 for a diagram representing the result of applying the first change model. On the other hand, the second display regions 304 and 305 include only first score display regions 3042 and 3052, respectively.

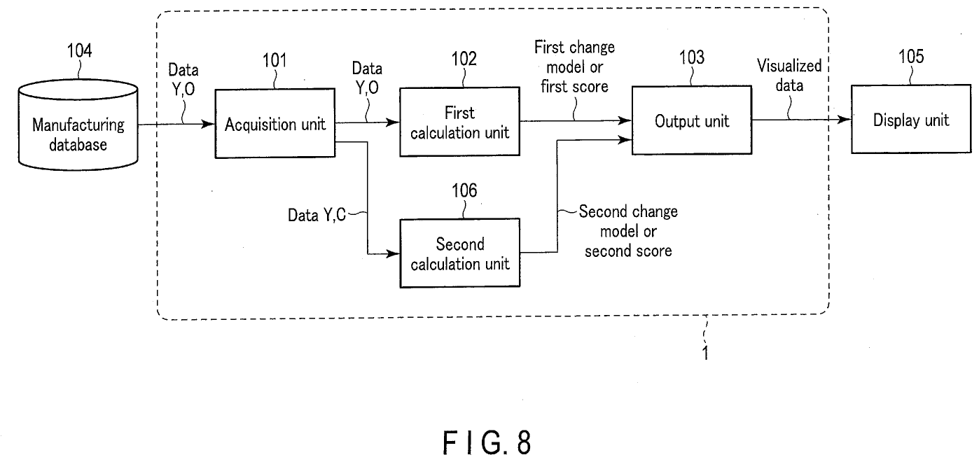

The amount of information displayed in each of the second display regions 303, 304, and 305 may be determined based on, for example, the value of the first score. For example, when the value of the first score is smaller than a predetermined threshold Th1, both the first score and the diagram representing the result of applying the first change model are displayed. In addition, when the value of the first score is larger than the predetermined threshold Th1 and smaller than a threshold Th2 larger than the threshold Th1, one of the first score and the diagram representing the result of applying the first change model, for example, the value of the first score is displayed. In addition, when the value of the first score is larger than the predetermined threshold Th2, for example, as indicated in the first score display region 3052 of FIG. 8, it may be displayed that the value of the score is larger than the threshold. In this case, the corresponding second display region itself may be hidden.

In addition, display priorities of the second display regions 303, 304, and 305 may also be determined according to the values of the first scores. For example, the priorities may be determined such that the second display regions are arranged from the top of the display screen in ascending order of the first scores.

In addition, when the value of the first score is smaller than the threshold Th1, the corresponding second display region may be highlighted. The highlighting can be performed by, for example, coloring the corresponding second display region, making bold the name of the order data displayed in the corresponding second display region, or adding a warning mark or the like to the corresponding second display region. On the other hand, when the value of the first score is larger than the threshold Th2, the corresponding second display region may be made unnoticeable. The second display region may be made unnoticeable by, for example, lightening a color of the second display region.

As described above, according to the first embodiment, the order data Oₖ related to the change in the state data Yᵢ is estimated based on the first score calculated using the state data Yᵢ related to the state of the product and the order data Oₖ related to the order related to the manufacturing of the product. That is, in the first embodiment, a process or the like related to the change in the state data Yᵢ can be estimated without using information directly indicating the cause of the change in the state data Yᵢ, such as information indicating how manufacturing conditions have been changed. Therefore, since the user does not need to monitor the state data one by one, it is expected that the burden on the user is reduced.

In the first embodiment, the priorities and amounts of information when the analysis result is displayed are determined based on the values of the first scores. Therefore, the user can preferentially check the order related to the manufacturing and expected to have a high relationship with the change in the state data Yᵢ, for example, a specific passage place during the manufacturing. Furthermore, since the number of places required to be checked is reduced, it is expected that the burden of checking on the user is reduced. Furthermore, it is expected that the user's oversight is reduced.

In addition, each of the first scores in the first embodiment indicates the likelihood of the cause of the change in the state data Yᵢ based on the presence or absence of the change in the state data Yᵢ caused by the order data Oₖ and the number of changes in the state data Yᵢ caused by the order data Oₖ. For example, in a case where the product is in a specific state such as an abnormal state due to an event such as different conditions before and after maintenance, different lots of members, or a failure of an apparatus that has been normally operated, the state data Yᵢ indicating the state of the product often changes when the specific event occurs in specific order. That is, in such a case, the state data Yᵢ can greatly change at a certain point of time as a boundary. When the specific event is the cause of the change in the state data Yᵢ, the number of changes in the state data Yᵢ in a process in which the specific event has occurred or the like is considered to be small. On the other hand, when a measurement error is included in the state data Yᵢ or the order of products is changed between processes, the state data Yᵢ may change complicatedly. Therefore, it is considered that the number of changes in the state data Yᵢ is large. Since the first score is a score that is based on the presence or absence of the change in the state data Yᵢ caused by the order data Oₖ and the number of changes in the state data Yᵢ caused by the order data Oₖ, and indicates the likelihood of the cause of the change in the state data Yᵢ, the first change model that fits the state data Yᵢ considered to be in a specific state such as an abnormal state can be determined. It can be estimated that the order or time that is indicated in the order data Oₖ from which the first change model is generated and that causes a change in the state data Yᵢ caused the state of the product to be a specific state such as an abnormal state. In this way, according to the first embodiment, the order data Oₖ related to the change in the state data Yᵢ can be estimated without using information of a change in the manufacturing conditions.

### Second Embodiment

Next, a second embodiment will be described. Similarly to the first embodiment, a data processing apparatus according to the second embodiment also estimates a cause of a certain state of a product by using order information, and visualizes the cause based on a result of the estimation. As a result, the data processing apparatus assists the user in finding the cause of the certain state of the product. In the first embodiment, the first calculation unit 102 calculates a first score regarding a change in the state data Yᵢ based on the order data Oₖ. On the other hand, when manufacturing condition data, which is information indicating conditions for manufacturing the product, can be acquired from a manufacturing database 104, a second score regarding a change in state data can be calculated based on the manufacturing condition data in a similar manner to the first score. If the first score and the second score are present, the relationship between the order causing the change in the state data and the manufacturing conditions can be presented to the user by comparing the first score with the second score. As described above, the second embodiment is an example applied to a case where the manufacturing condition data can be acquired. Description of parts similar to those described in the first embodiment will be omitted or simplified, and only parts different from those described in the first embodiment will be described.

FIG. 8 is a block diagram illustrating the data processing apparatus according to the second embodiment. The data processing apparatus 1 includes an acquisition unit 101, a first calculation unit 102, an output unit 103, and a second calculation unit 106. Similarly to the first embodiment, the data processing apparatus 1 is connected to the manufacturing database 104 and a display unit 105.

In the second embodiment, the acquisition unit 101 acquires manufacturing data. In the second embodiment, the manufacturing data is data to be used for calculating the first score and the second score, and includes key data for identifying each product, state data related to a state of each product, order data related to order related to the manufacturing of each product, and manufacturing condition data related to conditions for manufacturing of each product. The acquisition unit 101 inputs the key data, the state data, and the order data among the manufacturing data to the first calculation unit 102. In addition, the acquisition unit 101 inputs the key data, the state data, and the manufacturing condition data among the manufacturing data to the second calculation unit 106.

The second calculation unit 106 calculates a second score regarding a change in the state data based on a second change model using the state data and the manufacturing condition data. The second score is a score indicating an extent to which the second change model fits the actual state data and the manufacturing condition data. The second change model represents a change in the state data using the manufacturing condition data.

The output unit 103 generates visualized data from the first score or information describing the first score, and the second score or information describing the second score. Then, the output unit 103 outputs the visualized data to the display unit 105. As in the first embodiment, the visualized data is data for visually presenting a user with a possible cause of a large change in the manufacturing data.

Next, an operation of the data processing apparatus 1 according to the second embodiment will be described. First, an operation of the acquisition unit 101 will be described. In the second embodiment, the acquisition unit 101 acquires the manufacturing data including the manufacturing condition data from the manufacturing database 104. The manufacturing condition data will be described below in detail. For the following description, the manufacturing condition data is represented by a set {Cⱼ: j=1 . . . M}. Here, M represents the number of items of the acquired manufacturing condition data.

In addition, as the manufacturing conditions recorded as the manufacturing condition data, information such as a name of a material used for the product and a name of an apparatus used for processing or assembling the product can be used. More generally, information on 5M1E can be used as the manufacturing conditions. 5M1E is a term in which acronyms of man, machine, material, method, measurement, and environment are arranged, and is widely known as six factors for managing a manufacturing process. Information of man includes information such as a name of a processing person. Information of machine includes information such as a name of an apparatus used for manufacturing the product, a name of a manufacturing line, and the state of the apparatus at the time of processing, such as a temperature and pressure in the apparatus. Information of material includes information such as an ID or a name of a material used for manufacturing the product and an ID or a name of a component constituting the product. Information of method includes information such as a method for processing the product and a type of a processing program. Information of measurement includes information such as a name of an apparatus where measurement is performed and a measurement position of the product where the measurement is performed. Information of environment includes information such as a building name of a factory where the measurement is performed and the temperature and humidity when the measurement is performed. The acquisition unit 101 acquires the manufacturing condition data from the manufacturing database 104 so as to include manufacturing conditions necessary for analysis. At this time, the acquisition unit 101 may acquire the manufacturing condition data so as to include manufacturing conditions determined by the user to be useful for analysis and visualization.

Next, an operation of the first calculation unit 102 will be described. When receiving state data Yᵢ and order data Oₖ from the acquisition unit 101, the first calculation unit 102 calculates a first score S1(Yᵢ, Oₖ). The first score is calculated in the same manner as in the first embodiment.

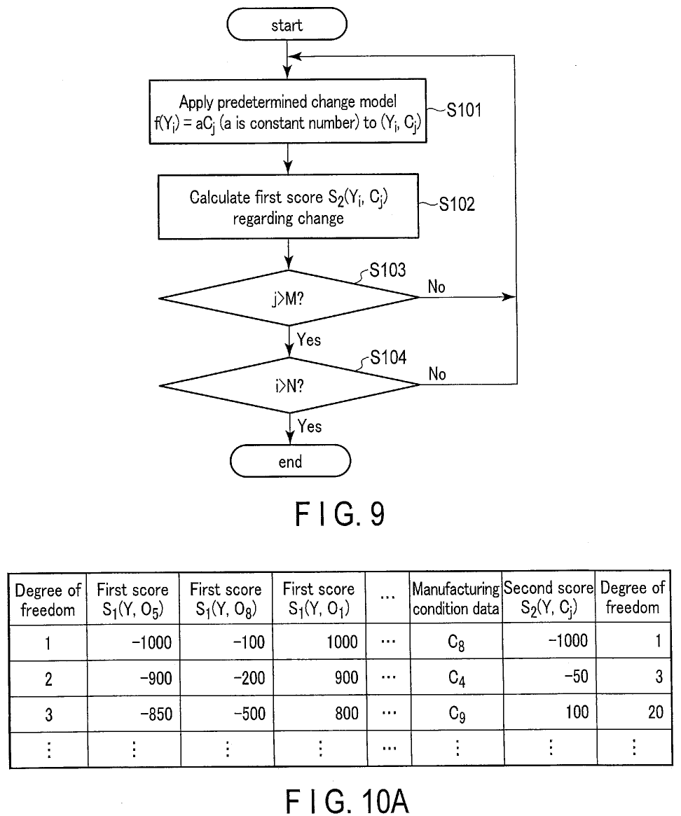

Next, an operation of the second calculation unit 106 will be described. When receiving the state data Yᵢ and manufacturing condition data Cⱼ from the acquisition unit 101, the second calculation unit 106 calculates a second score S2(Yᵢ, Cⱼ). FIG. 9 is a flowchart illustrating processing of calculating the second score in the second calculation unit 106. Here, the second score may be calculated basically by the same method as the method for calculating the first score. Therefore, the description of FIG. 9 is simplified.

First, the second calculation unit 106 initializes i and j to initial values, for example, 1. Then, in step S101, the second calculation unit 106 applies a second change model ƒ(Yᵢ)=aCⱼ to one set of the state data Yᵢ and the manufacturing condition data Cⱼ. The second change model represents a change in the state data Yᵢ using the manufacturing condition data Cⱼ. The second change model may be a regression model similar to the first change model. The second change model may be, for example, a regression model using the manufacturing condition data Cⱼ as a step basis.

Here, in a case where the manufacturing condition data Cⱼ is data of a nominal scale such as an ID of a material or of a component and the name of the material or of the component, the second change model is applied after the manufacturing condition data Cⱼ is converted into a dummy variable by a method such as one-hot encoding. The method for converting the manufacturing condition data Cⱼ into the dummy variable is not limited to one-hot encoding. For example, as the method for converting the manufacturing condition data Cⱼ into the dummy variable, a method such as label encoding, count encoding, target encoding, or leave one out encoding may be used. In addition, in a case where the manufacturing condition data Cⱼ is data to which the regression model can be applied without being converted into a dummy variable such as a ratio scale, it is not necessary to use these conversion methods.

In step S102, the second calculation unit 106 calculates a second score S2(Yᵢ, Cⱼ) regarding a change in the state data Yᵢ. The second score S2 (Yᵢ, Cⱼ) is the goodness of fit of the second change model to the state data Yᵢ and the manufacturing condition data Cⱼ. The second score is desirably a score that can be compared with the first score. For example, a BIC similar to the first score can be used as the second score. Of course, each score that can be used as the first score may be used as the second score. With the second score, an extent to which the second change model can explain the change in the state data Yᵢ can be evaluated as a numerical value. For example, by displaying the ranking of first scores and the ranking of second scores in parallel, the user can evaluate which item of the order data Oₖ and the manufacturing condition data Cⱼ is likely to be the cause of the change in the state data Yᵢ.

In step S103, the second calculation unit 106 determines whether j is larger than M. In a case where it is determined in step S103 that j is not larger than M, the second calculation unit 106 adds 1 to j and then returns the processing to step S101. In a case where it is determined in step S103 that j is larger than M, that is, in a case where it is determined that the processing for all the manufacturing condition data Cⱼ for the current state data Yᵢ has been completed, the second calculation unit 106 causes the processing to proceed to step S104.

In step S104, the second calculation unit 106 determines whether i is larger than N. In a case where it is determined in step S104 that i is not larger than N, the second calculation unit 106 adds 1 to i and then returns the processing to step S101. In a case where it is determined in step S104 that i is larger than N, that is, in a case where it is determined that the processing for all the manufacturing condition data Cⱼ for all the state data Yᵢ has been completed, the second calculation unit 106 ends the processing illustrated in FIG. 9. In this case, the second calculation unit 106 outputs the second score or information describing the second score obtained in the processing illustrated in FIG. 9 to the output unit 103. The information describing the second score is, for example, a result of applying the second change model to the state data Yᵢ to calculate the second score. The result of applying the second change model to the state data Yᵢ to calculate the second score can be, for example, data of a function representing the state data Yᵢ, the manufacturing condition data Cⱼ, and the second change model that most suitably fits the state data Yᵢ and the manufacturing condition data Cⱼ.

Next, an operation of the output unit 103 will be described. After the first score is calculated by the first calculation unit 102 and the second score is calculated by the second calculation unit 106, the output unit 103 generates visualized data from the first score or the information describing the first score and the second score or the information describing the second score. The output unit 103 may further perform processing of comparing the first score with the second score. When the cause of the change in the state data Y±occurs at a certain timing and the order of products is changed, the first score is considered to be a score equivalent to the score of the true cause. Therefore, by comparing the first score with the second score, it can be determined to what extent the corresponding manufacturing condition data Cⱼ is likely to be the cause of the change. For example, when the first score and the second score are almost the same, it is determined that the change in the corresponding manufacturing condition data Cⱼ is likely to be the cause of the change in the state data Yᵢ. On the other hand, when the first score and the second score are different, it cannot be said that the change in the corresponding manufacturing condition data Cⱼ is likely to be the cause of the change in the state data Yᵢ. In this case, it is suggested that there is another cause. Therefore, in such a case, the output unit 103 may generate the visualized data so as to notify the user of the possibility that there is another cause of the change.

The first score to be compared with the second score will be described. First, the degree of freedom in calculating the second score is determined based on the number −1 of conditions of the manufacturing condition data Cⱼ. The number of conditions of the manufacturing condition data Cⱼ is the number of elements included in the manufacturing condition data Cⱼ. For example, when one of two processing conditions can be selected as a processing condition in a certain process, the number of conditions of the manufacturing condition data Cⱼ is two, and the degree of freedom in calculating the second score is one. On the other hand, the degree of freedom in calculating the first score can take all values from 0 to L−1. Therefore, the degree of freedom of the first score when the first score and the second score are compared may be the degree of freedom at the time of the maximum likelihood score. For example, in a case where the BIC is used, the degree of freedom of the first score when the first score and the second score are compared may be the degree of freedom when the BIC is minimized. As another method, the degree of freedom of the order data Oₖ may be limited. For example, by adjusting the degree of freedom of the order data Oₖ to the number of elements of the manufacturing condition data. Cⱼ, the comparison can be performed while suppressing excessive fit to the order data Oₖ. In the case of performing the calculation after designating the degree of freedom as described above, a greedy algorithm, an orthogonal matching pursuit (OMP) algorithm, lasso regression, or a derivative method thereof may be used. In these methods, it is possible to obtain a score by designating not only the degree of freedom of the maximum likelihood but also an arbitrary degree of freedom and performing regression calculation. Therefore, these techniques are suitable techniques.

Further, to compare the first score with the second score, a Δ score that is a difference value between the two scores may be used as a reference value of the comparison. For example, when the Δ score is 0, it indicates that the first score and the second score are exactly the same value. In addition, the larger the value of the Δ score, the larger the difference between the first score and the second score. In a case where the first score and the second score are compared on the assumption that the first score is equivalent to the true cause as in the present embodiment, the smaller the A score, the higher the possibility that the manufacturing condition data Cⱼ corresponding to the second score at that time is likely to be the true cause, and the larger the Δ score, the higher the possibility that there is a different cause from the manufacturing condition data Cⱼ corresponding to the second score at that time. That is, by using the Δ score, the reliability for the true cause of the manufacturing condition data Cⱼ can be presented. The Δ score in a case where each of the first score and the second score is the BIC has a relationship shown in Formula (3) with the Bayesian factor BF01 shown in Jeffreys, H. 1961. Theory of probability. Oxford University Press.

Δ score˜21nBF01 (3)

Based on Formula (3), a value obtained by taking a logarithm of the reference value and doubling the logarithm may be treated as a reference value for comparison based on the Δ score. Of course, the user may set an appropriate reference value according to the situation. As a result, the comparison result can be evaluated according to the user's needs.

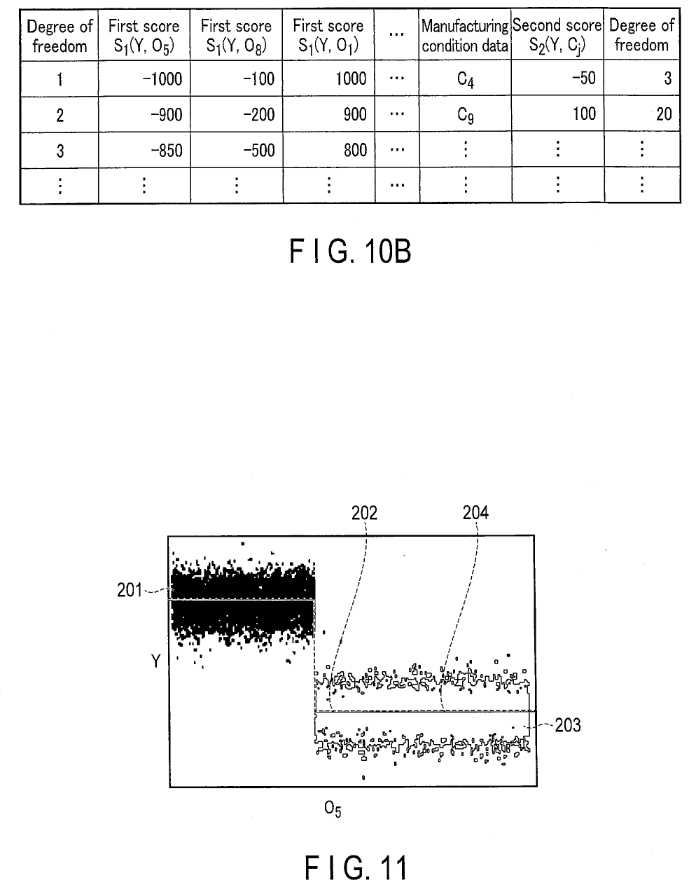

FIG. 10A is a diagram illustrating an example of data generated by the output unit 103 when manufacturing condition data Cⱼ that has caused a change in the state data Yᵢ has been acquired. FIG. 10A illustrates an example of a case where first scores and second scores for the state data Yᵢ are compared. In FIG. 10A, the order data Oₖ and the manufacturing condition data Cⱼ are sorted in ascending order of the scores. The order in which the data is sorted is not limited to the order of the scores, and may be the order of ease for the user to view the data, such as the processing order. According to FIG. 10A, order data O_{S} indicates the minimum first score when the degree of freedom is 1. The value of the minimum first score for the order data O_{S} matches the value of the second score for manufacturing condition data C₈. This indicates that the manufacturing condition data C₈ is likely to be the cause of the change in the state data Yᵢ. As a result, the user can consider the cause of the change in the state data Yᵢ from numerical values.

FIG. 10B is a diagram illustrating an example of data generated by the output unit 103 when manufacturing condition data Cⱼ that has caused a change in the state data Yᵢ has not been acquired. In FIG. 10B, since the manufacturing condition data C₈ has not been acquired, both the Δ score between the value of the minimum first score for the order data O_{S} and the value of the second score for manufacturing condition data C₄ and the Δ score between the value of the minimum first score for the order data O_{S} and the value of the second score for manufacturing condition data C₉ are large values. This indicates that a manufacturing condition other than the manufacturing condition data C₄ and the manufacturing condition data C₉ causes a change in the state data Yᵢ. In this case, by comparing the first scores, the order related to the manufacturing and causing the change in the state data Yᵢ can be specified. In the example of FIG. 10B, the first score when the degree of freedom of the order data O_{S} is 1 is the smallest. Therefore, it can be estimated that a change in the state data Yᵢ has occurred at the timing of the order data O_{S}.

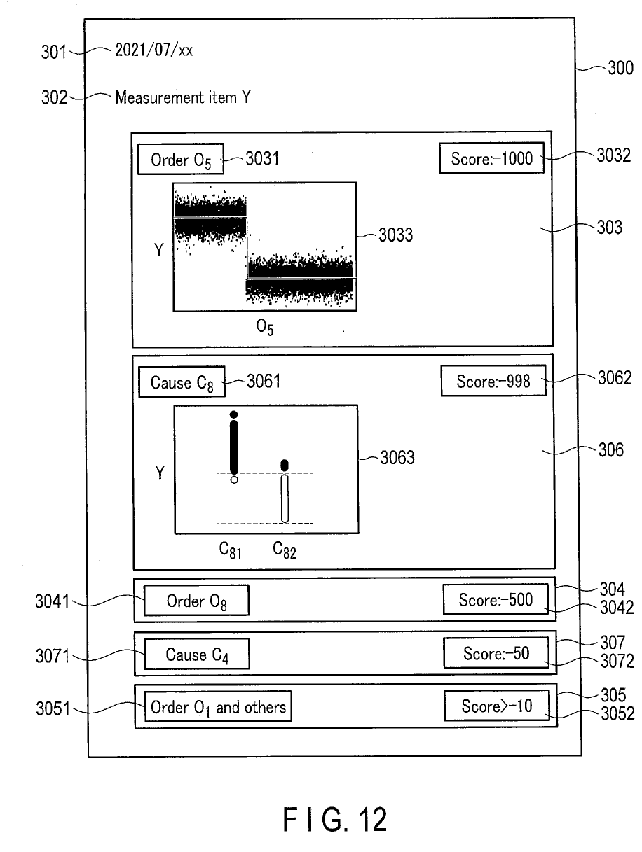

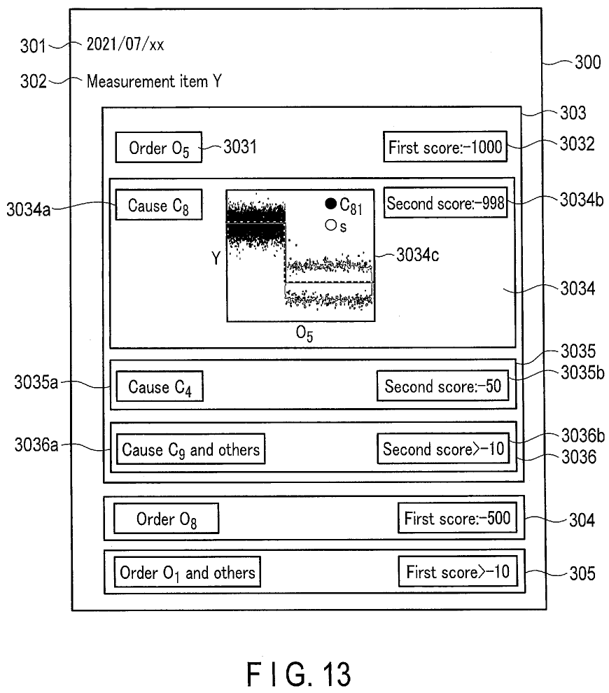

Furthermore, the diagram related to the manufacturing condition data Cⱼ may be, for example, a scatter diagram corresponding to FIG. 6, in which the vertical axis represents the value of the state data Yᵢ and the horizontal axis represents the value of the manufacturing condition data Cⱼ. In addition, the diagram related to the manufacturing condition data Cⱼ may be, for example, a diagram in which the relationship between the manufacturing condition data Cⱼ and the state data Yᵢ, such as a scatter diagram and a histogram in which the vertical axis represents the value of the state data Yᵢ and the horizontal axis represents the value of the manufacturing condition data Cⱼ, can be grasped. On the other hand, when the information of the order data Oₖ can also be acquired as in the present embodiment, the visualization may be performed using a scatter diagram in which the order data Oₖ, the manufacturing condition data Cⱼ, and the state data Yᵢ as illustrated in FIG. 11 are combined. In FIG. 11, the vertical axis represents the value of the state data Yᵢ and the horizontal axis represents each point of time of certain order data Oₖ, for example, order data O_{S}. In FIG. 11, a polygonal line 202 of a first change model applied based on the order data O_{S} and a polygonal line 204 of the second change model applied based on the manufacturing condition data C₈ highly related to the order data O_{S} are displayed on a scatter diagram 201, and the display mode of a part 203 of the scatter diagram 201 is adjusted according to the content of the manufacturing condition data C₈. The display mode is adjusted by adjusting, for example, a color. In FIG. 11, black dots are plotted in the scatter diagram before a change in the manufacturing condition data C₈, and white dots are plotted in the scatter diagram after the change in the manufacturing condition data C₈. With the display as illustrated in FIG. 11, the user can easily intuitively grasp the result based on the order data O_{S} and the result based on the manufacturing condition data C₈ with respect to the distribution of the state data Yᵢ. In FIG. 11, as the adjustment of the display mode, the colors of the plotted dots are properly used according to the change in the manufacturing condition data Cⱼ. On the other hand, the adjustment of the display mode is not limited to changing the color of the plotted dots. For example, the adjustment of the display mode may be performed by any method in which a change in the manufacturing condition data Cⱼ can be visually distinguished by changing the shape of the plotted dots or the like.

An operation of the output unit 103 will be described. FIG. 12 is a diagram illustrating an example of a display screen of an analysis result displayed on the display unit 105 when the first score, the result of applying the first change model, and the second score are received. The display screen illustrated in FIG. 12 is displayed based on the visualized data. As illustrated in FIG. 12, the display screen of the analysis result includes a first display region 300. The first display region 300 includes a creation date display field 301, a state data name display field 302, and second display regions 303, 304, 305, 306, and 307. FIG. 12 is an example of a display screen in a case where one piece of state data Yᵢ to be analyzed is present. When two or more pieces of state data Yᵢ are present, first display regions 300 for all the state data Yᵢ may be displayed side by side. Furthermore, in a case where any score is calculated for each piece of state data Yᵢ, the first display region 300 for each piece of the state data Yᵢ may be displayed in the ranking order based on the scores.

The creation date display field 301 and the state data name display field 302 in the first display region 300 are similar to those illustrated in FIG. 7. Therefore, descriptions thereof are omitted.

The second display regions 303, 304, and 305 are display regions for displaying information on a combination of the state data Yᵢ and the order data Oₖ displayed in the corresponding first display region 300. On the other hand, the second display regions 306 and 307 are display regions for displaying information on the combination of the state data Yᵢ and the manufacturing condition data Cⱼ displayed in the corresponding first display region 300. A maximum of L x M second display regions can be provided for one first display region.

The second display regions 303, 304, and 305 include order data name display fields 3031, 3041, and 3051, respectively. In addition, each of the second display regions 303, 304, and 305 includes at least one of a display region for a first score and a display region for a diagram representing a result of applying the first change model. For example, the second display region 303 includes both a first score display region 3032 and a display region 3033 for a diagram representing the result of applying the first change model. On the other hand, the second display regions 304 and 305 do not include the display region for the diagram representing the result of applying the first change model, but include first score display regions 3042 and 3052, respectively.

The second display regions 306 and 307 include manufacturing condition data name display fields 3061 and 3071, respectively. Each of the second display regions 306 and 307 includes at least one of a display region for a second score and a display region for a scatter diagram representing a relationship between the manufacturing condition data and the state data. For example, the second display region 306 includes both a second score display region 3062 and a display region 3063 for a scatter diagram representing the relationship between the manufacturing condition data and the state data. On the other hand, the second display region 307 does not include the display region for the scatter diagram representing the relationship between the manufacturing condition data and the state data, but includes a second score display region 3072. The scatter diagram representing the relationship between the manufacturing condition data and the state data can be generated, for example, by plotting the state data Yᵢ corresponding to each piece of the manufacturing condition data Cⱼ. In FIG. 11, C₈₁ indicates the manufacturing condition data C₈ before the change, and C₈₂ indicates the manufacturing condition data C₈ after the change.

The amount of information displayed in each of the second display regions may be determined based on, for example, the value of the first score and the value of the second score. For example, when the value of the first score is smaller than a predetermined threshold Th1, both the first score and the diagram representing the result of applying the first change model are displayed. In addition, when the value of the first score is larger than the predetermined threshold Th1 and smaller than a threshold Th2 larger than the threshold Th1, one of the first score and the diagram representing the result of applying the first change model, for example, the value of the first score is displayed. For example, when the value of the second score is smaller than a predetermined threshold Th3, both the second score and the diagram representing the result of applying the second change model are displayed. In addition, when the value of the second score is larger than the predetermined threshold Th3 and smaller than a threshold Th4 larger than the threshold Th3, one of the second score and the diagram representing the result of applying the second change model, for example, the value of the second score is displayed. In addition, when the value of the second score is larger than the predetermined threshold Th4, for example, it may be displayed that the value of the score is larger than the threshold, similarly to the first score. In this case, the corresponding second display region itself may be hidden. Note that the threshold Th1 and the threshold Th3 may be the same value. Note that the threshold Th2 and the threshold Th4 may be the same value.

When manufacturing condition data Cⱼ indicating the second score equivalent to the first score is present, the second display region related to the manufacturing condition data Cⱼ may be highlighted. The second display region can be highlighted by, for example, changing a color of a frame, making bold the name of a manufacturing condition, displaying a specific mark, or the like.

In addition, each of display priorities of the second display regions 303, 304, 305, 306, and 307 may also be determined according to the values of the first scores and the values of the second scores. In this case, in a case where the first scores and the second scores can be compared, the first scores and the second scores are compared together, and the priorities may be determined such that the second display regions are arranged from the top of the display screen in ascending order of the score values. On the other hand, when the first scores and the second scores cannot be compared, the priorities may be determined such that the first scores and the second scores are separately compared, the second display regions based on the order data are arranged in ascending order of the values of the first scores, and the second display regions based on the manufacturing condition data are arranged in ascending order of the values of the second scores.

Instead of the scatter diagram representing the relationship between the manufacturing condition data and the state data illustrated in FIG. 12, a scatter diagram in which the order data Oₖ, the manufacturing condition data Cⱼ, and the state data Yᵢ as illustrated in FIG. 11 are combined may be displayed.

FIG. 13 is a diagram illustrating an example of a display screen of an analysis result when a scatter diagram in which the order data Oₖ, the manufacturing condition data Cᵢ, and state data Yᵢ are combined is displayed. In the example of FIG. 13, second display regions 3034, 3035, and 3036 for the manufacturing condition data C₈, C₄, and C₉ related to the order data Oₖ having the smallest first score in the second display region 303, or related to the order data O_{S} in the example, are displayed. The second display regions 3034, 3035, and 3036 include manufacturing condition data name display fields 3034a, 3035a, and 3036a, respectively. In addition, each of the second display regions 3034, 3035, and 3036 includes at least one of a display region for a second score and a display region for the scatter diagram in which the order data Oₖ, the manufacturing condition data Cⱼ, and the state data Yᵢ are combined. For example, the second display region 3034 includes a display region 3034b for a second score and a scatter diagram display region 3034c. On the other hand, the second display regions 3035 and 3036 include only second score display regions 3035b and 3036b, respectively. The amount of information displayed in each of the second display regions 3034, 3035, and 3036 may be determined based on, for example, the value of the second score.

With the scatter diagram in which the order data Oₖ, the manufacturing condition data Cⱼ, and the state data Yᵢ are combined, a change in the state data Yᵢ accompanying a change in the manufacturing condition data Cⱼ with reference to the order data Oₖ can be visually distinguished. Therefore, the user can easily evaluate the manufacturing condition data Cⱼ based on the order data Oₖ.

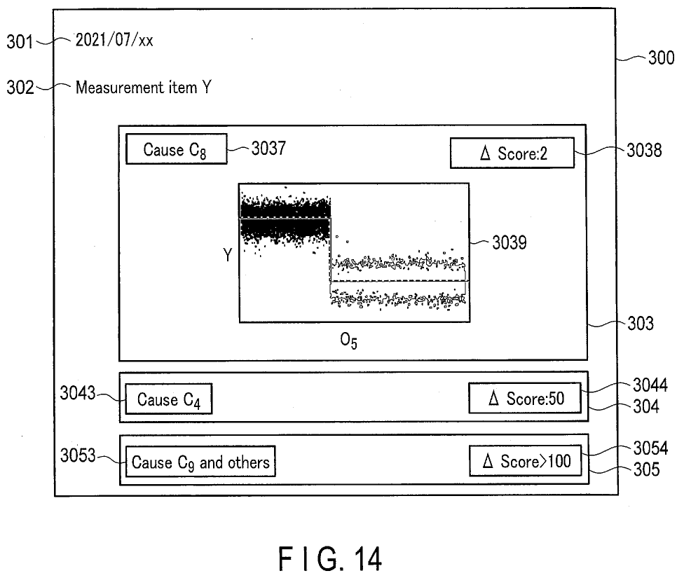

In a case where the degree of freedom in calculating the first score matches the number of elements of the manufacturing condition data Cⱼ when the second score is calculated, the display screen including the second display regions 303, 304, and 305 as illustrated in FIG. 14 can also be displayed. Description will be given with reference to FIG. 14.

The second display regions 303, 304, and 305 include manufacturing condition data name display fields 3037, 3043, and 3053, respectively. In addition, each of the second display regions 303, 304, and 305 includes at least one of a display region for the Δ score and the display region for the scatter diagram in which the order data Oₖ, the manufacturing condition data Cⱼ, and the state data Yᵢ are combined. For example, the second display region 303 includes a display region 3038 for the score and a display region 3039 for the scatter diagram in which the order data Oₖ, the manufacturing condition data Cⱼ, and the state data Yᵢ are combined. On the other hand, the second display regions 304 and 305 include only the display regions 3044 and 3054 for Δ scores, respectively. Each of the second display regions may include an order data name display field instead of the manufacturing condition data name display fields 3037, 3043, and 3053.

The amount of information displayed in each of the second display regions 303, 304, and 305 may be determined based on, for example, the value of the Δ score. For example, when the value of the Δ score is within a threshold range R1 that is a range close to 0, both the Δ score and the scatter diagram in which the order data Oₖ, the manufacturing condition data Cᵢ, and the state data Yᵢ are combined are displayed. When the value of the Δ score is out of the threshold range R1 and is within a threshold range R2 wider than the threshold range R1, any one of the Δ score and the scatter diagram in which the order data Oₖ, the manufacturing condition data Cⱼ, and the state data Yᵢ are combined, for example, the value of the Δ score is displayed. Similarly, when the value of the Δ score is out of the threshold range R2, it may be displayed that the value of the Δ score is out of the threshold range. In this case, the corresponding second display region itself may be hidden.

In addition, display priorities of the second display regions 303, 304, and 305 may also be determined according to the values of the Δ scores. For example, the priorities may be determined such that the second display regions are arranged from the top of the display screen in ascending order of the Δ scores.

When the value of the Δ score is within the threshold range R1, the corresponding second display region may be highlighted. The highlighting can be performed by, for example, coloring the corresponding second display region, making bold the name of the manufacturing condition data or the order data displayed in the corresponding second display region, or adding a warning mark or the like to the corresponding second display region. Conversely, when the value of the Δ score is out of the threshold range R2, the corresponding second display region may be made unnoticeable. The second display region may be made unnoticeable by, for example, lightening a color of the second display region.

As described above, according to the second embodiment, in addition to the first embodiment, the manufacturing condition data Cⱼ related to the change in the state data Yᵢ is estimated based on the second score calculated using the state data Yᵢ related to the state of the product and the manufacturing condition data Cⱼ related to the conditions for the manufacturing of the product. The user can evaluate whether or not a change in the corresponding manufacturing condition data Cⱼ is likely to be a cause of a change in the state data Yᵢ by comparing the first score with the second score.

In addition, in the second embodiment, the priority and the amount of information when the analysis result is displayed are determined based on both the first score and the second score. Therefore, the user can preferentially check the order related to the manufacturing and the manufacturing conditions that are expected to have a high relationship with the change in the state data Yᵢ.

### Third Embodiment

Next, a third embodiment will be described. Similarly to the first embodiment and the second embodiment, a data processing apparatus according to the third embodiment also estimates a cause of a certain state of a product by using order information, and visualizes the cause based on a result of the estimation. As a result, the data processing apparatus assists the user in finding the cause of the certain state of the product.

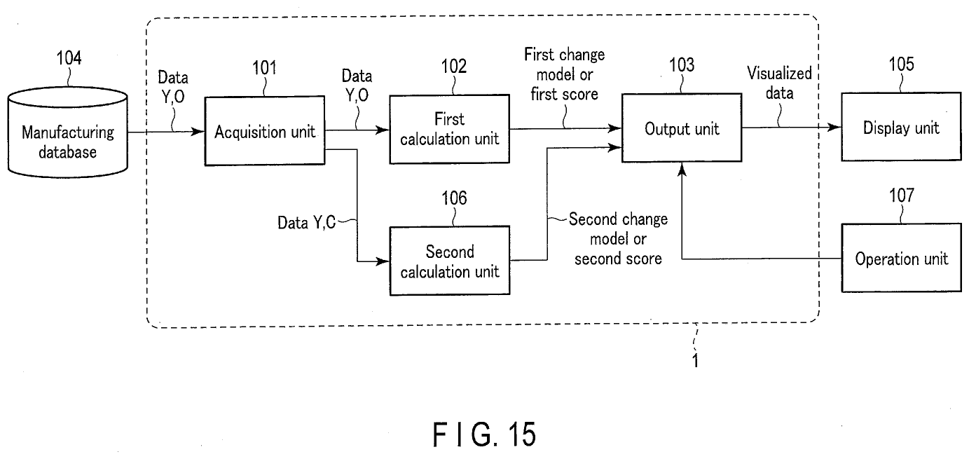

FIG. 15 is a block diagram illustrating the data processing apparatus according to the third embodiment. The data processing apparatus 1 includes an acquisition unit 101, a first calculation unit 102, a second calculation unit 106, and an output unit 103. In the third embodiment, the output unit 103 is connected to an operation unit 107. For example, the operation unit 107 may be provided separately from the data processing apparatus 1 or may be provided in the data processing apparatus 1. The third embodiment is different from the first and second embodiments in that the content of visualized data generated by the output unit 103 is changed according to an operation from the operation unit 107 in the third embodiment. More specifically, an amount of information displayed and a priority displayed are changed according to the operation. Description of parts similar to those described in the second embodiment will be omitted or simplified, and only parts different from those described in the second embodiment will be described below. Note that the operation unit 107 may be included in the data processing apparatus 1 according to the first embodiment, instead of being included in the data processing apparatus 1 described in the second embodiment. An operation in this case is also similar to an operation of the third embodiment described below.

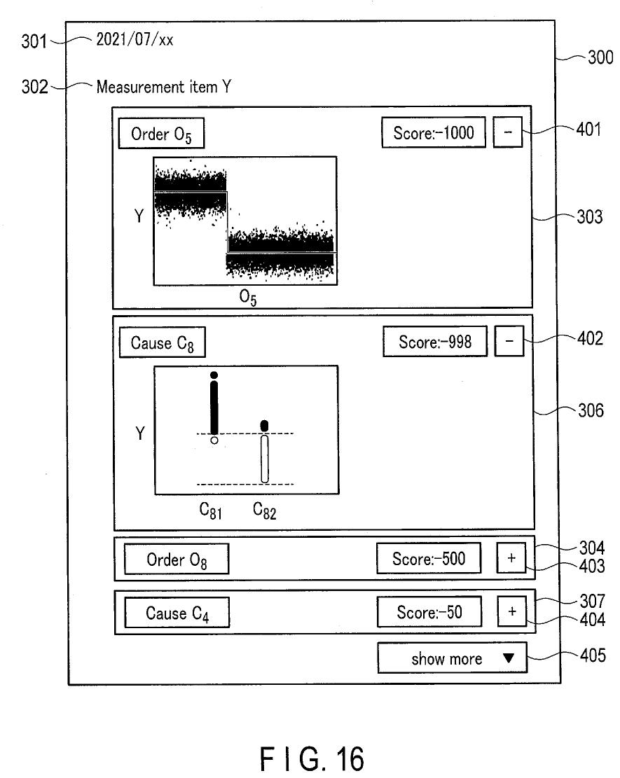

FIG. 16 is a diagram illustrating an example of a display screen displayed on a display unit 105 in the third embodiment. The display screen illustrated in FIG. 16 includes a first display region 300 similar to that on the display screen illustrated in FIG. 12. In FIG. 16, the first display region 300 includes second display regions 303, 304, 306, and 307. The first display region 300 may further include the second display region 305 illustrated in FIG. 12. In addition, the first display region 300 may be the first display region 300 illustrated in FIG. 7, the first display region 300 illustrated in FIG. 13, or the first display region 300 illustrated in FIG. 14.

In FIG. 16, the second display regions 303, 306, 304, and 307 further include information amount change buttons 401, 402, 403, and 404, respectively. When any one of the information amount change buttons 401, 402, 403, and 404 is selected by the operation unit 107, the amount of information in the corresponding second display region increases or decreases.

For example, the second display region 303 illustrated in FIG. 16 is in a state where the amount of information is increasing. In the second display region 303, the name of order data, a first score, and a diagram representing a result of applying a first change model are displayed. When the information amount change button 401 is selected in this state, the amount of information in the second display region 303 decreases. Specifically, in the second display region 303, only the name of the order data and the first score are displayed. When the amount of information decreases, the second display region is displayed on the display unit 105 so as to be folded, for example. The display when the amount of information is changed from the increased state to the decreased state may be reduced display or the like instead of the folded display.

On the other hand, the second display region 304 illustrated in FIG. 16 is in a state where the amount of information is decreasing. Specifically, in the second display region 304, only the name of order data and the first score are displayed. When the information amount change button 404 is selected in this state, the amount of information in the second display region 304 increases. Specifically, in the second display region 304, a diagram representing the result of applying the first change model is displayed in addition to the name of the order data and the first score. When the amount of information increases, the second display region is displayed on the display unit 105 so as to be expanded, for example. The display when the amount of information is changed from the decreased state to the increased state may be enlarged display or the like instead of the enlarged display.

The information amount change buttons 401, 402, 403, and 404 desirably include information related to changes in amounts of information of the second display regions. The information related to the changes in the amounts of the information of the second display regions is, for example, “+” and “−”. Specifically, “+” may be displayed on the information amount change buttons 401, 402, 403, and 404 when the amounts of information of the second display regions are increasing, and “−” may be displayed on the information amount change buttons 401, 402, 403, and 404 when the amounts of information of the corresponding second display regions are decreasing.

In addition, the first embodiment and the second embodiment describe the case where the second display region in which the first score or the second score is larger than the corresponding threshold is hidden. In the third embodiment, the first display region 300 includes a switch button 405 for switching between display and non-display of a second display region in which a first score or a second score is larger than a threshold. For example, while the display of the switch button 405 is “show more”, the second display region in which the first score or the second score is larger than the threshold is hidden in the folded state. When the switch button 405 is selected in this state, the second display region in the folded state is displayed. Then, the display of the switch button 405 is switched to “hide”. When the switch button 405 is selected in this state, the second display region in which the first score or the second score is larger than the threshold is hidden again in the folded state. All second display regions in the folded state may be displayed, or a predetermined number of second display regions in the folded state may be displayed. The order in which the second display regions are displayed may be determined by the first scores and/or the second scores. In a case where the predetermined number of second display regions are displayed, only a display region with the first score and/or the second score higher than those in the other display regions may be displayed.

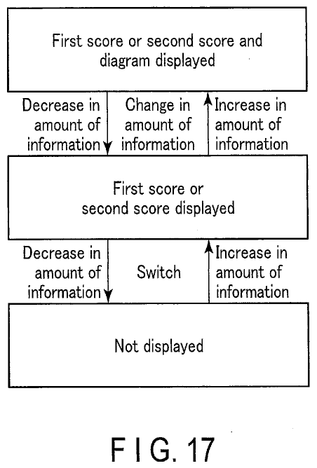

FIG. 17 is a schematic diagram illustrating a relationship between the information amount change button, the switch button, and the amount of information of the second display region according to the third embodiment. As illustrated in FIG. 17, the amount of information of the second display region in which the first score or the second score and a diagram representing a result of applying a model are displayed is the largest. The amount of information of a second display region that is not displayed is the smallest. The amount of information of the second display region is increased or decreased by the information amount change button and the switch button.

As described above, the same number of first display regions as the number of pieces of the state data Yᵢ to be analyzed may be present. In a case where a plurality of pieces of state data Yᵢ to be analyzed are present, an information amount change button and a switch button may be provided for each first display region.

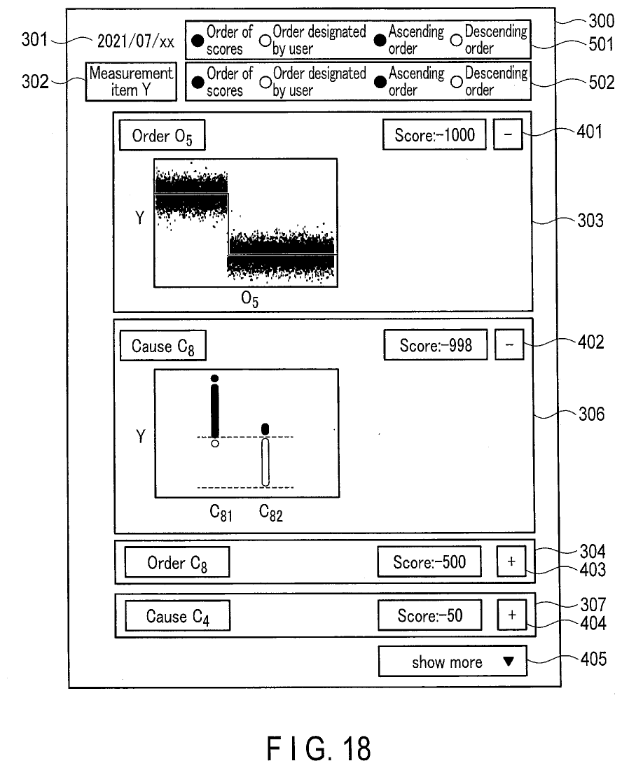

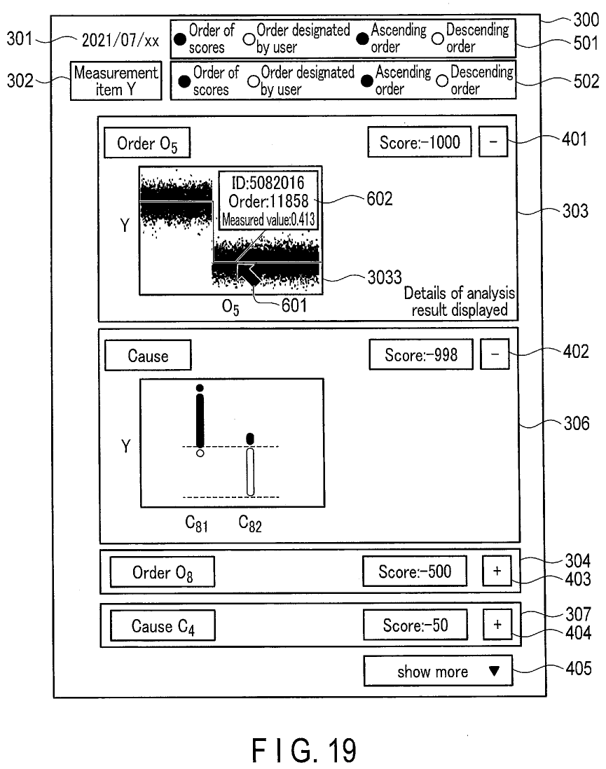

FIG. 18 is a diagram illustrating an example of a display screen including an interface for accepting an operation of changing a priority of a first display region and an operation of changing a priority of a second display region. A display screen illustrated in FIG. 18 includes a first display region 300 similar to that on the display screen illustrated in FIG. 16. In FIG. 18, the first display region 300 includes second display regions 303, 304, 306, and 307. The first display region 300 may further include the second display region 305 illustrated in FIG. 12. In addition, the first display region 300 may be the first display region 300 illustrated in FIG. 7, the first display region 300 illustrated in FIG. 13, or the first display region 300 illustrated in FIG. 14.

In FIG. 18, the first display region 300 further includes priority change buttons 501 and 502. The priority change button 501 includes a radio button for receiving an operation of setting the order of display priorities of a plurality of first display regions to the order of scores or the order designated by the user, and a radio button for receiving an operation of setting the order of the priorities to the ascending order or the descending order of the scores, or the ascending order designated by the user or the descending order designated by the user. The priority change button 502 includes a radio button for receiving an operation of setting the order of display priorities of a plurality of second display regions to the order of scores or the order designated by the user, and a radio button for receiving an operation of setting the order of the priorities to the ascending order or the descending order of the scores, or the ascending order designated by the user or the descending order designated by the user. The ascending order of the scores is, for example, the ascending order of scores of lower ones of the first scores and the second scores. Similarly, the descending order of the scores is, for example, the descending order of scores of higher ones of the first scores and the second scores. The order designated by the user can be arbitrarily designated by the user, for example, the order of the first scores, the order of the second scores, or the like.

In FIG. 18, the first display regions or the second display regions are rearranged according to the priorities designated by the priority change button 501 or the priority change button 502.

FIG. 18 illustrates the radio buttons as an interface for changing the priorities. The interface for changing the priorities may be a check box, a pull-down menu, or the like. When the state data name display field 302 is selected, the priority change buttons 501 and 502 may be displayed in the corresponding first display region 300.

As illustrated in FIG. 19, when a cursor 601 is positioned on the scatter diagram in the display region 3033 for the diagram representing the result of applying the first change model, details 602 of the result of analyzing the position of the cursor 601 may be displayed. The details of the analysis result can include, for example, an ID, a measured value of the corresponding state data Yᵢ, an order value in the corresponding order data Oₖ, and the like. In a case where a plurality of display regions are present for displaying the diagram representing the result of applying the first change model or in a case where a plurality of analysis results are already generated, a button for displaying details of the analysis results may be separately provided. In this case, when the button is selected, details of the plurality of analysis results may be displayed.

In addition, the first display region 300 may include an interface for changing the thresholds for the first scores and the second scores.

As described above, in the third embodiment, for the state data Yᵢ, the order data Oₖ, and the manufacturing condition data Cⱼ related to the state of the product, the amount of information and the priority to be displayed in the second display region are determined based on the first score or the second score regarding the change in the state data Yᵢ. In addition, the user can change the amount of information and the display priority of the second display region via the operation unit 107. In addition, the user can change the amount of information and the display priority of the first display region via the operation unit 107. As a result, the user can not only preferentially monitor information expected to have a high relationship with an abnormality, but also check the analysis result in a more diversified manner. For example, in a daily monitoring task, the user can properly use the display region to check an item expected to have a high relationship with an abnormality displayed first, and monitor an item having a relatively low relationship with an abnormality in a scene where detailed monitoring is required.

### Fourth Embodiment

Next, a fourth embodiment will be described. Similarly to the first to third embodiments, a data processing apparatus according to the fourth embodiment also estimates a cause of a certain state of a product by using order information, and visualizes the cause based on a result of the estimation. As a result, the data processing apparatus assists the user in finding the cause of the certain state of the product.

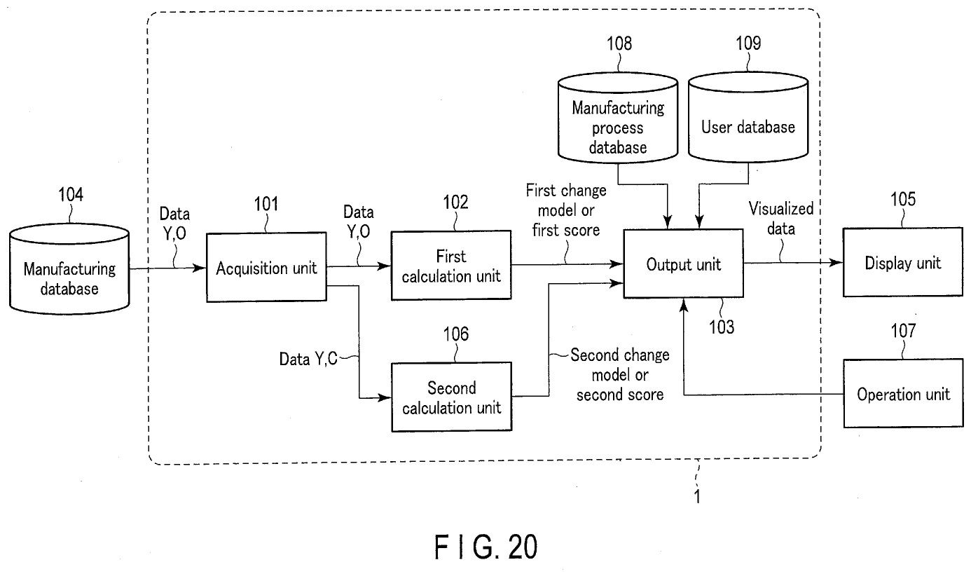

FIG. 20 is a block diagram illustrating the data processing apparatus according to the fourth embodiment. The data processing apparatus 1 includes an acquisition unit 101, a first calculation unit 102, a second calculation unit 106, an output unit 103, a manufacturing process database 108, and a user database 109. In the fourth embodiment, the output unit 103 generates visualized data according to manufacturing process data recorded in the manufacturing process database 108 and user data recorded in the user database 109.

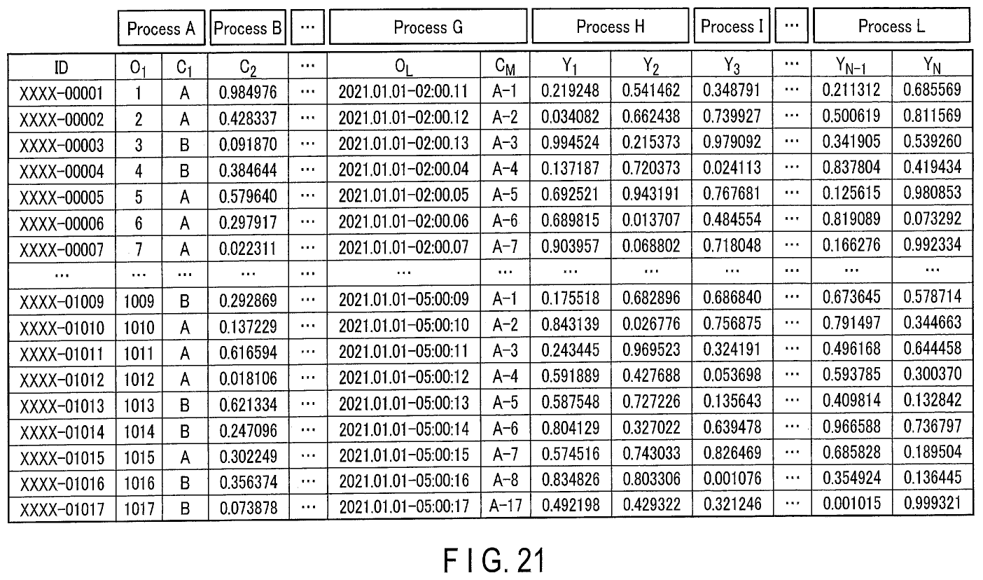

The manufacturing process database 108 records the manufacturing process data indicating a process of manufacturing the product. Usually, a subdivided task until the final commercialization is completed is called a manufacturing process. Manufacturing data is usually recorded for each process. The manufacturing process data in the present embodiment is data indicating which manufacturing process each item of the manufacturing data acquired by the acquisition unit 101 belongs to. FIG. 21 is a diagram illustrating a relationship between the manufacturing data and the manufacturing process data. For example, in FIG. 21, order data O₁ and manufacturing condition data C₁ belong to a process A of the manufacturing process data. Such data indicating which process each of state data Yᵢ, order data Oₖ, and manufacturing condition data Cⱼ belongs to is the manufacturing process data. In the fourth embodiment, the output unit 103 generates visualized data using not only a first score or a second score but also the manufacturing process data.

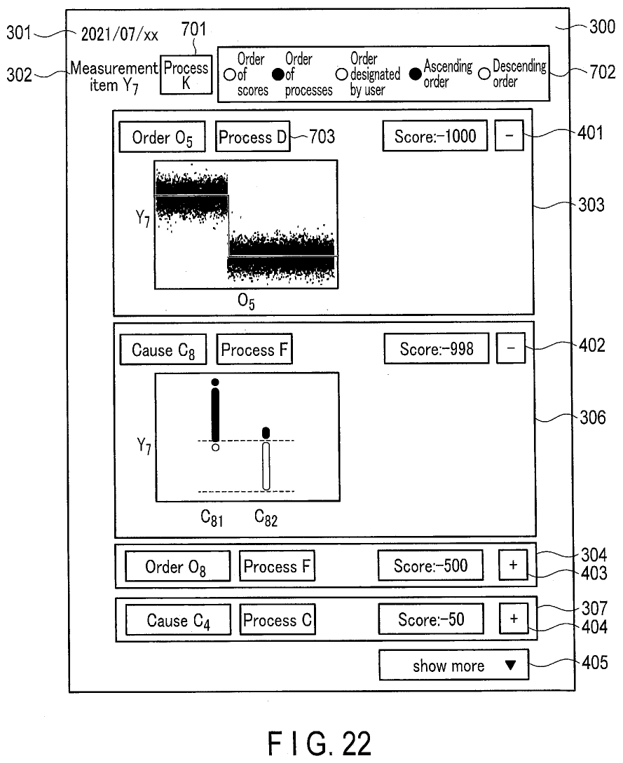

FIG. 22 is a diagram illustrating an example of a display screen displayed on a display unit 105 in the fourth embodiment. A display screen illustrated in FIG. 22 includes a first display region 300 similar to that on the display screen illustrated in FIG. 16. In FIG. 22, the first display region 300 includes second display regions 303, 304, 306, and 307. The first display region 300 may further include the second display region 305 illustrated in FIG. 12. In addition, the first display region 300 may be the first display region 300 illustrated in FIG. 7, the first display region 300 illustrated in FIG. 13, or the first display region 300 illustrated in FIG. 14.

In FIG. 22, the first display region 300 includes a manufacturing process name display field 701 and a priority change button 702. The manufacturing process name display field 701 is a display field for displaying a name of a manufacturing process to be analyzed among manufacturing processes to which the current state data Yᵢ to be analyzed belongs. The priority change button 702 includes a radio button for receiving an operation of setting the order of display priorities of a plurality of first display regions to the order of scores, the order of processes, or the order designated by the user, and a radio button for receiving an operation of setting the order of the priorities to the ascending order or the descending order of the scores, the ascending order or the descending order of the processes, or the ascending order designated by the user or the descending order designated by the user.

The first display regions are rearranged according to priorities designated by the priority change button 702. For example, in FIG. 22, when the ascending order of the processes is designated, the first display regions are rearranged in the order in which manufacturing processes to which the state data Y7 to be measured belongs are started.

In FIG. 22, each second display region also includes a manufacturing process name display field 703. The manufacturing process name display field 703 is a display field for displaying a name of a manufacturing process to which the order data Oₖ or the manufacturing condition data Cⱼ of the corresponding second display region belongs. For example, FIG. 22 illustrates that order data O_{S} having the smallest first score belongs to a process D. In FIG. 22, state data Y₇ in a process K is, for example, data indicating an abnormality, and thus is to be analyzed, but the second display region 303 indicates that the cause of a change in the state data Y₇ is the process D.

The first display region 300 may include an interface for changing the thresholds for the first score and the second score for each process. Such an interface is effective when a process in which an abnormality easily occurs and a process in which an abnormality hardly occurs are known.

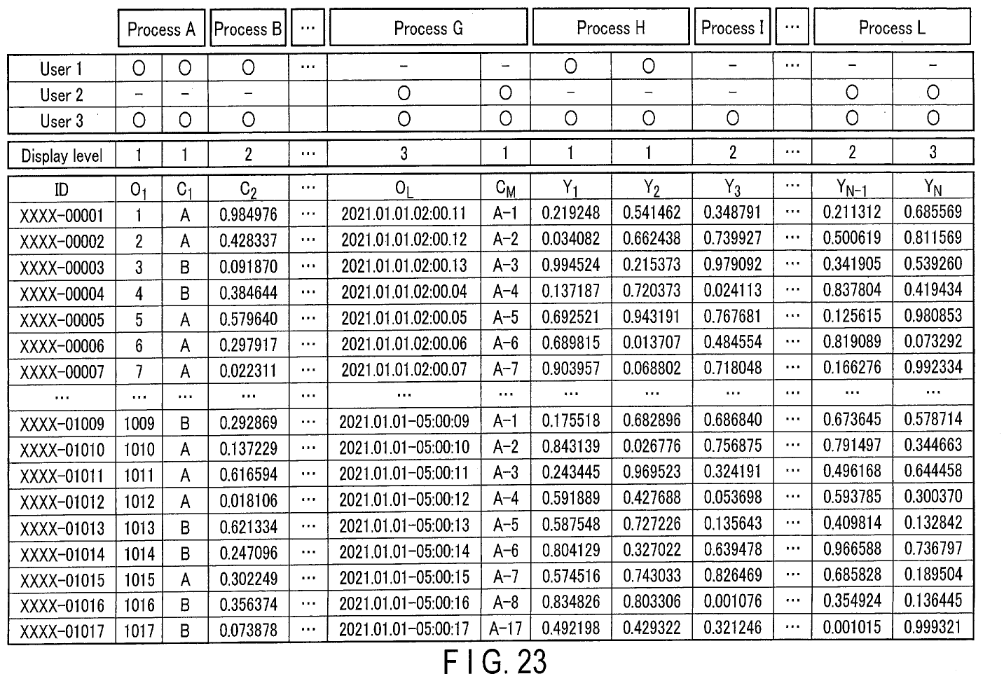

The user database 109 records user data of a user who performs analysis. As the user in the embodiment, for example, a worker of each manufacturing process, a manager of each manufacturing process, a manager of the entire manufacturing, or the like is assumed. The user data is data indicating a priority at the time of display for each attribute of the user. FIG. 23 is a diagram illustrating a relationship between the manufacturing data and the user data. The user data may be, for example, data indicating whether or not to display each measured value. In FIG. 23, the result of analyzing manufacturing data marked with a circle is displayed. On the other hand, the result of analyzing manufacturing data not marked with a circle is not displayed. The user data may be, for example, data indicating whether or not to perform display for each manufacturing process. In this case, for example, only an analysis result related to a process in charge of the user is displayed.

The user data may include numerical data indicating the level of the user. For example, an analysis result related to some manufacturing data may be displayed for a user with a low numerical value, and an analysis result related to a large number of manufacturing data may be displayed for a user with a high numerical value. For example, the numerical value of the level of an inexperienced user may be set low, and the numerical value of the level of an expert or an administrator may be set high. In FIG. 23, the numerical values are set in three stages, but are not necessarily set in three stages.

As described above, according to the fourth embodiment, the visualized data is generated based on not only the score but also the manufacturing process data. As a result, it is possible to enable display that is easy for the user to monitor, such as displaying analysis results in the order of the manufacturing processes. Furthermore, by using not only the score but also the user data, it is possible to enable display according to a target to be monitored by the user who uses the user data and/or the skill level of the user. As a result, the burden on the user can be reduced.

In the fourth embodiment, the manufacturing process database 108 and the user database 109 are included in the data processing apparatus 1. However, the manufacturing process database 108 and the user database 109 may be provided separately from the data processing apparatus 1.

### Fifth Embodiment

Next, a fifth embodiment will be described. Similarly to the first to fourth embodiments, a data processing apparatus according to the fifth embodiment also estimates a cause of a certain state of a product by using order information, and visualizes the cause based on a result of the estimation. As a result, the data processing apparatus assists the user in finding the cause of the certain state of the product.

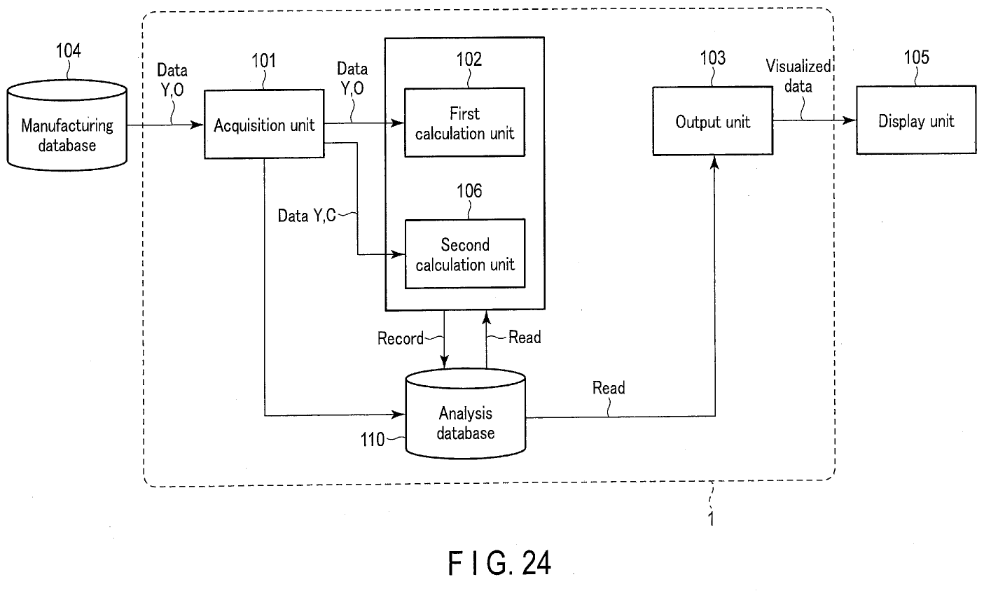

FIG. 24 is a block diagram illustrating the data processing apparatus according to the fifth embodiment. The data processing apparatus 1 includes an acquisition unit 101, a first calculation unit 102, a second calculation unit 106, an output unit 103, and an analysis database 110. Note that the analysis database 110 may be included in the data processing apparatus 1 according to the first embodiment, instead of being included in the data processing apparatus 1 according to the second embodiment. An operation in this case is also similar to an operation in the fifth embodiment described below.

In the fifth embodiment, the first calculation unit 102 records a first score or information describing the first score in the analysis database 110. Similarly, the second calculation unit 106 records a second score or information describing the second score in the analysis database 110.

In addition, in the fifth embodiment, the acquisition unit 101 records data related to acquired manufacturing data in the analysis database 110. For example, the acquisition unit 101 records data of conditions for acquiring a manufacturing condition such as a time period for acquiring the manufacturing data.

In addition, in the fifth embodiment, the output unit 103 generates visualized data using the data recorded in the analysis database 110. For example, the output unit 103 may generate a graph representing the transition of the first score and the second score in addition to the diagram representing the result of applying the first change model described above and the diagram representing the result of applying the second change model described above. In addition, the output unit 103 may generate visualized data that enables a previous analysis result to be compared with a current analysis result.

As described above, in the fifth embodiment, the past first score or information describing the first score, and the second score or information describing the past second score are recorded in the analysis database 110. As a result, it is possible to provide the visualized data without applying the change models again or the like. This is effective for monitoring daily manufacturing data and the like.

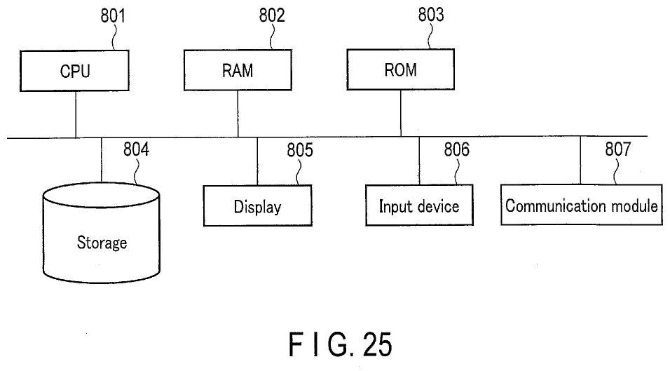

Next, a hardware configuration of each of the data processing apparatuses according to the above-described embodiments will be described. FIG. 25 is a block diagram illustrating the hardware configuration of each of the data processing apparatuses 1. The data processing apparatus 1 includes a central processing unit (CPU) 801, a random access memory (RAM) 802, a read only memory (ROM) 803, a storage 804, a display 805, an input device 806, and a communication module 807. The CPU 801, the RAM 802, the ROM 803, the storage 804, the display 805, the input device 806, and the communication module 807 are connected to each other via a bus. Note that the display 805 may not be included in the data processing apparatus 1 and may be a peripheral apparatus of the data processing apparatus 1.

The CPU 801 is a processor that executes arithmetic processing, control processing, and the like according to a program. The CPU 801 uses a predetermined area of the RAM 802 as a work area, and executes various processes as the acquisition unit 101, the first calculation unit 102, the second calculation unit 106, and the output unit 103 described above in cooperation with programs stored in the ROM 803, the storage 804, and the like.

The RAM 802 is a memory such as a synchronous dynamic random access memory (SDRAM). The RAM 802 functions as a work area of the CPU 801. The ROM 803 is a memory that stores programs and various types of information in a non-rewritable manner.

The storage 804 is an apparatus that writes and reads data to and from a semiconductor storage medium such as a flash memory, a magnetically recordable storage medium such as a hard disk drive (HDD), an optically recordable storage medium, or the like. The storage 804 writes and reads data to and from the storage medium under the control of the CPU 801. The storage 804 may operate as the manufacturing database 104, the manufacturing process database 108, the user database 109, and the analysis database 110. The manufacturing database 104, the manufacturing process database 108, the user database 109, and the analysis database 110 may be stored in a storage medium different from the storage 804.

The display 805 is a liquid crystal display (LCD) or the like. The display 805 operates as the display unit 105, and displays various display screens such as the display screen illustrated in FIG. 7 based on a display signal from the CPU 801.

The input device 806 is an input device that includes a mouse and a keyboard. The input device 806 operates as the operation unit 107, receives information input based on an operation by the user as an instruction signal, and outputs the instruction signal to the CPU 801.

The communication module 807 communicates with an external device via a network in accordance with control from the CPU 801.

The instructions indicated in the processing procedures described in the above-described embodiments can be executed based on a program that is software. By storing this program in advance and reading this program, a general-purpose computer system can obtain effects similar to the effects of the data processing apparatuses described above. The instructions described in the above-described embodiments are recorded in a magnetic disk (flexible disk, hard disk, or the like), an optical disc (CD-ROM, CD-R, CD-RW, DVD-ROM, DVD±R, DVD±RW, Blu-ray (registered trademark) disc, or the like), a semiconductor memory, or a recording medium similar thereto as the program that can be executed by a computer. The storage format may be any form as long as the recording medium is readable by a computer or an embedded system. When the computer reads the program from the recording medium and causes a CPU to execute an instruction described in the program based on the program, it is possible to implement an operation similar to those of the data processing apparatuses according to the above-described embodiments. Of course, in a case where the computer acquires or reads the program, the computer may acquire or read the program via a network.

In addition, an operating system (OS) running on the computer, database management software, middleware (MW) such as a network, or the like may execute a part of each of the processes for implementing the present embodiment based on an instruction of the program installed in the computer or the embedded system from the recording medium.

Furthermore, the recording medium in the present embodiment is not limited to the medium independent of the computer or the embedded system, and includes a recording medium that downloads and stores or temporarily stores the program transmitted via a LAN, the Internet, or the like.

Furthermore, the number of recording media is not limited to one. Also in a case where the processing in the present embodiment is executed from a plurality of media, the media may be included in the recording medium in the present embodiment, and each of the configurations of the media may be any configuration.

Note that the computer or the embedded system in the present embodiment is for executing each of the processes in the present embodiment based on the program stored in the recording medium, and may have any configuration such as an apparatus including one of a personal computer, a microcomputer, and the like, a system in which a plurality of apparatuses are connected to a network, or the like.

In addition, the computer in the present embodiment is not limited to a personal computer, and includes an arithmetic processing apparatus, a microcomputer, and the like included in an information processing apparatus, and collectively refers to a device and an apparatus that are capable of implementing the functions in the present embodiment by the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising a processor including hardware configured to:
acquire state data related to a state of each product and order data related to order related to manufacturing of each product;
calculate a first score by using the acquired state data and the acquired order data, the first score regarding a change in the acquired state data and being based on a first change model, the first change model representing the change in the state data using the order data; and
output the first score.

2. The data processing apparatus according to claim 1, wherein
the order data indicates order in which the product has undergone a predetermined manufacturing process in manufacturing the product, or indicates time when the product has undergone the predetermined manufacturing process in manufacturing the product.

3. The data processing apparatus according to claim 1, wherein
the processor generates, according to the first score, visualized data for displaying at least one of the first score and information describing the first score on a display.

4. The data processing apparatus according to claim 3, wherein
the processor is further configured to:
calculate a plurality of first scores for a plurality of pieces of order data; and
generate the visualized data such that each of the first scores or information describing each of the first scores is displayed with a priority corresponding to the first scores.

5. The data processing apparatus according to claim 3, wherein
the processor is further configured to:
calculate a plurality of first scores for a plurality of pieces of order data; and
generate the visualized data such that an amount of information displayed as each of the first scores or information describing each of the first scores changes according to the first scores.

6. The data processing apparatus according to claim 1, wherein
the processor calculates the first score using a regression method for the first change model.

7. The data processing apparatus according to claim 6, wherein
the processor calculates the first score based on goodness of fit of the first change model to the state data and the order data and a penalty of complexity of the first change model.

8. A data processing apparatus comprising a processor including hardware configured to:
acquire state data related to a state of each product, order data related to order related to manufacturing of each product, and manufacturing condition data related to conditions for manufacturing each product;
calculate a first score by using the acquired state data and the acquired order data, the first score regarding a change in the acquired state data and being based on a first change model, the first change model representing the change in the state data using the order data;
calculate a second score by using the acquired state data and the acquired manufacturing condition data, the second score regarding a change in the acquired state data and being based on a second change model, the second change model representing the change in the state data using the manufacturing condition data; and
output the first score and the second score.

9. The data processing apparatus according to claim 8, wherein
the order data indicates order in which the product has undergone a predetermined manufacturing process in manufacturing the product, or indicates time when the product has undergone the predetermined manufacturing process in manufacturing the product.

10. The data processing apparatus according to claim 8, wherein
the processor generates, according to the first score and the second score, visualized data for displaying at least one of the first score and information describing the first score and at least one of the second score and information describing the second score on a display.

11. The data processing apparatus according to claim 10, wherein
the processor is further configured to:
calculate a plurality of first scores for a plurality of pieces of order data;
calculate a plurality of second scores for a plurality of pieces of manufacturing condition data; and
generate the visualized data such that each of the first scores or information describing each of the first scores is displayed with a priority corresponding to the first scores, and that each of the second scores or information describing each of the second scores is displayed with a priority corresponding to the second scores.

12. The data processing apparatus according to claim 10, wherein
the processor is further configured to:
calculate a plurality of first scores for a plurality of pieces of order data;
calculate a plurality of second scores for a plurality of pieces of manufacturing condition data; and
generate the visualized data such that an amount of information displayed as each of the first scores or information describing each of the first scores changes according to the first scores, and that an amount of information displayed as each of the second scores or information describing each of the second scores changes according to the second scores.

13. The data processing apparatus according to claim 10, wherein
the processor generates the visualized data according to reliability calculated based on the first score and the second score.

14. The data processing apparatus according to claim 10, wherein
the processor generates the visualized data so as to highlight or make unnoticeable at least one of the first score, the information describing the first score, the second score, and the information describing the second score according to the first score and the second score.

15. The data processing apparatus according to claim 8, wherein
the processor calculates the first score according to the number of conditions of the manufacturing condition data.

16. The data processing apparatus according to claim 8, wherein
the processor is further configured to:
calculate the first score using a regression method for the first change model; and
calculate the second score using a regression method for the second change model.

17. The data processing apparatus according to claim 16, wherein
the processor is further configured to:
calculate the first score based on goodness of fit of the first change model to the state data and the order data and a penalty of complexity of the first change model; and
calculate the second score based on goodness of fit of the second change model to the state data and the manufacturing condition data and a penalty of complexity of the second change model.

18. A data processing method comprising:
acquiring state data related to a state of each product and order data related to order related to manufacturing of each product;
calculating a first score by using the acquired state data and the acquired order data, the first score regarding a change in the acquired state data and being based on a first change model, the first change model representing the change in the state data using the order data; and
outputting the first score.

19. A data processing method comprising:
acquiring state data related to a state of each product, order data related to order related to manufacturing of each product, and manufacturing condition data related to conditions for manufacturing each product;
calculating a first score by using the acquired state data and the acquired order data, the first score regarding a change in the acquired state data and being based on a first change model, the first change model representing the change in the state data using the order data; and
calculating a second score by using the acquired state data and the acquired manufacturing condition data, the second score regarding a change in the acquired state data and being based on a second change model, the second change model representing the change in the state data using the manufacturing condition data; and
outputting the first score and the second score.

20. A non-transitory computer-readable storage medium storing a data processing program for causing a computer to:
acquire state data related to a state of each product and order data related to order related to manufacturing of each product;
calculate a first score by using the acquired state data and the acquired order data, the first score regarding a change in the acquired state data and being based on a first change model, the first change model representing the change in the state data using the order data; and
output the first score.

21. A non-transitory computer-readable storage medium storing a data processing program for causing a computer to:
acquire state data related to a state of each product, order data related to order related to manufacturing of each product, and manufacturing condition data related to conditions for manufacturing each product;
calculate a first score by using the acquired state data and the acquired order data, the first score regarding a change in the acquired state data and being based on a first change model, the first change model representing the change in the state data using the order data;
calculate a second score by using the acquired state data and the acquired manufacturing condition data, the second score regarding a change in the acquired state data and being based on a second change model, the second change model representing the change in the state data using the manufacturing condition data; and
output the first score and the second score.
